(19) United States
(12) Patent Application Publication
(10) Pub. No.: US 2025/0139481 A1
(43) Pub. Date: May 1, 2025

(54) SYNTHESIS OF QUANTUM CIRCUITS FOR PREPARING SUPERPOSED STATES

(71) Applicant: International Business Machines Corporation, Armonk, NY (US)

(72) Inventors: Gadi Aleksandrowicz, Haifa (IL); Shelly-Erika Garion, Haifa (IL); Alexander Ivrii, Haifa (IL); Ali Javadiabhari, Sleepy Hollow, NY (US); Bibek Pokharel, San Jose, CA (US)

(21) Appl. No.: 18/498,273

(22) Filed: Oct. 31, 2023

(51) Int. Cl. G06N 10/40; G06N 10/20

(52) U.S. Cl. CPC G06N 10/40; G06N 10/20

(57) ABSTRACT

A process is provided to generate a quantum circuit for preparing a target superposed state of a quantum bit register on a connectivity graph which comprises labeled edges and vertexes. The process comprises generating an initial layer of the quantum circuit which comprises a single-qubit gate to place the quantum bit register in an initial superposed state, and generating a sequence of layers following the initial layer, to generate the target superposed state. The sequence of layers comprises a plurality of layers of a same type of a controlled two-qubit gate which conditionally flips a state of a target quantum bit based on a state of a control quantum bit. A number of unique layers of the plurality of layers of the same type of a controlled two-qubit gate is no greater than a number of unique labels in a given set of labels for the connectivity graph.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

This disclosure relates generally to quantum computing and, in particular, to techniques for synthesizing quantum circuits for quantum computations. As is known in the art, quantum computing provides a computing paradigm which utilizes fundamental principles of quantum mechanics to perform computations. Quantum computing algorithms and applications are defined using quantum circuits. A quantum circuit is a model for quantum computation, similar to classical circuits, wherein a quantum computation comprises a sequence of quantum gates, measurements, and initializations of quantum bits or quantum bit registers to known states. A quantum circuit is a computational routine which defines coherent quantum operations that are performed on quantum data that is stored in quantum bits, in conjunction with operations that are performed using classical computation. Quantum circuits are utilized to define complex algorithms and applications in an abstract manner, which can be executed on a quantum computer. In a quantum computer, primitive operations comprise gates operations, e.g., single-qubit gate operations, two-qubit gate operations, multi-qubit gate operations (e.g., 3 or more qubits) that are applied to qubits, to perform quantum computing operations for a given application. The gate operations are defined through quantum logic synthesis of quantum circuits that are constructed using gates derived from a universal gate library. The quantum circuits allow a quantum computer to receive classical data, perform quantum operations based on the received data, and output a classical solution.

While quantum algorithms provide accelerated processing speed over classical algorithms for solving complex problems, the quantum states of quantum bits are highly susceptible to noise, which can lead to errors in the execution of quantum algorithms. Such noise typically arises from the evolution of quantum states, since gate operations can be a primary cause of noise that leads to errors. In this regard, it is desirable to implement optimal algorithms for synthesizing quantum circuits with a minimal number of gates and layers, etc., for the purposes of, e.g., minimizing error rates, reducing execution times of quantum operations, etc.

### SUMMARY

Exemplary embodiments of the disclosure include techniques for synthesizing quantum circuits for quantum computations and, in particular, techniques for synthesizing quantum circuits for preparing superposed states.

For example, an exemplary embodiment includes a device which comprises a memory that is configured to store program instructions, and processing circuitry, coupled to the memory. The processing circuitry is configured to execute the program instructions to perform a process to generate a quantum circuit for preparing a target superposed state of a quantum bit register on a connectivity graph which comprises edges and vertexes in which each edge is assigned one label of a given set of unique labels such that no vertex of the connectivity graph is incident to two edges assigned with a same label. In performing the process, the processing circuitry is configured to: generate an initial layer of the quantum circuit, wherein the initial layer comprises a single-qubit gate that is configured to place the quantum bit register in an initial superposed state; and generate a sequence of layers of the quantum circuit following the initial layer, which are configured to generate the target superposed state of the quantum bit register, wherein the sequence of layers comprises a plurality of layers of a same type of controlled two-qubit gate that is configured to conditionally flip a state of a target quantum bit based on a state of a control quantum bit. A number of unique layers of the plurality of layers of the same type of controlled two-qubit gate in the sequence of layers is no greater than a number of unique labels in the given set of labels for the connectivity graph.

Advantageously, exemplary quantum circuit synthesis techniques as described herein enable high density synthesis of quantum circuits for preparing superposed states of quantum bit registers, wherein the quantum circuits for preparing the superposed states are constructed with minimal depths and minimal numbers of unique layers of the same type of controlled two-qubit gate (e.g., controlled-NOT gate).

In another exemplary embodiment, a method comprises generating a quantum circuit for preparing a target superposed state of a quantum bit register on a connectivity graph which comprises edges and vertexes in which each edge is assigned one label of a given set of unique labels such that no vertex of the connectivity graph is incident to two edges assigned with a same label. The quantum circuit is generated by a process which comprises: generating an initial layer of the quantum circuit, wherein the initial layer comprises a single-qubit gate that is configured to place the quantum bit register in an initial superposed state; and generating a sequence of layers of the quantum circuit following the initial layer, which are configured to generate the target superposed state of the quantum bit register, wherein the sequence of layers comprises a plurality of layers of a same type of controlled two-qubit gate that is configured to conditionally flip a state of a target quantum bit based on a state of a control quantum bit. A number of unique layers of the plurality of layers of the same type of controlled two-qubit gate in the sequence of layers is no greater than a number of unique labels in the given set of labels for the connectivity graph.

Another exemplary embodiment includes a computer program product for performing a process to generate a quantum circuit for preparing a target superposed state of a quantum bit register on a connectivity graph which comprises edges and vertexes in which each edge is assigned one label of a given set of unique labels such that no vertex of the connectivity graph is incident to two edges assigned with a same label. The computer program product comprises one or more computer readable storage media, and program instructions collectively stored on the one or more computer readable storage media. The program instructions comprise: program instructions to generate an initial layer of the quantum circuit, wherein the initial layer comprises a single-qubit gate that is configured to place the quantum bit register in an initial superposed state; and program instructions to generate a sequence of layers of the quantum circuit following the initial layer, which are configured to generate the target superposed state of the quantum bit register, wherein the sequence of layers comprises a plurality of layers of a same type of controlled two-qubit gate that is configured to conditionally flip a state of a target quantum bit based on a state of a control quantum bit. A number of unique layers of the plurality of layers of the same type of controlled two-qubit gate in the sequence of layers is no greater than a number of unique labels in the given set of labels for the connectivity graph.

In another exemplary embodiment, as may be combined with the preceding paragraphs, each layer of the same type of controlled two-qubit gate comprises a set of the controlled two-qubit gates which correspond to edges in the connectivity graph which are assigned the same label.

In another exemplary embodiment, as may be combined with the preceding paragraphs, each controlled two-qubit gate corresponds to a respective pair of quantum bits represented by a respective pair of vertexes in the connectivity graph, which is connected by an edge.

In another exemplary embodiment, as may be combined with the preceding paragraphs, the quantum circuit is generated by a process which comprises performing a backward iterative process that is configured to start with the target superposed state of the quantum bit register and determine a sequence of the plurality of layers of the same type of controlled two-qubit gate in a reverse order until reaching a state of the quantum bit register in which only one quantum bit of the quantum bit register has a state of 1 to which the single-qubit gate in the initial layer of the quantum circuit is applied.

In another exemplary embodiment, as may be combined with the preceding paragraphs, the quantum circuit is generated by a process which comprises performing a forward iterative process that is implemented using the connectivity graph having a tree structure with a root node that is initialized with a state of 1, wherein the forward iterative process propagates the state of the root node down to nodes of the tree structure to generate a sparse state.

In another exemplary embodiment, as may be combined with the preceding paragraphs, the process for generating the quantum circuit comprises: generating a quantum circuit to prepare the sparse state; and adding one or more layers to the quantum circuit to produce the target superposed state of the quantum bit register from the sparse state.

In another exemplary embodiment, as may be combined with the preceding paragraphs, the process for generating the quantum circuit comprises: generating a sparse state of the target superposed state on a linear nearest-neighbor connected graph; generating a quantum circuit to prepare the sparse state; and adding one or more layers to the quantum circuit to produce the target superposed state of the quantum bit register from the sparse state.

In another exemplary embodiment, as may be combined with the preceding paragraphs, in generating the sparse state of the target superposed state on the linear nearest-neighbor connected graph, the process derives the linear nearest-neighbor connected graph from a grid array of quantum bits.

Other embodiments will be described in the following detailed description of exemplary embodiments, which is to be read in conjunction with the accompanying figures.

### BRIEF DESCRIPTION OF THE DRAWINGS

FIG. 1A schematically illustrates a quantum circuit that is configured to estimate ground state energies of a quantum system.

FIG. 1B schematically illustrates the quantum circuit of FIG. 1A which comprises a quantum state preparation circuit to prepare an initial superposed quantum state for an n-qubit register, according to an exemplary embodiment of the disclosure.

FIG. 2 schematically illustrates an edge-colored connectivity graph, which can be utilized to generate quantum circuits for preparing a superposed quantum state of n-qubit registers on an edge-colored connectivity graph, according to an exemplary embodiment of the disclosure.

FIG. 3 schematically illustrates a quantum circuit comprising a plurality of unique CX-layers of a quantum state preparation circuit for preparing an initial superposed quantum state for an n-qubit register, according to an exemplary embodiment of the disclosure.

FIG. 4 schematically illustrates a quantum state preparation circuit for preparing a superposed quantum state of a multi-qubit register, according to an exemplary embodiment of the disclosure.

FIGS. 5A and 5B illustrate an exemplary process for generating a quantum circuit that is configured to prepare a superposed quantum state of a multi-qubit register, according to an exemplary embodiment of the disclosure.

FIGS. 6A and 6B illustrate an exemplary process for generating a quantum circuit that is configured to prepare a superposed quantum state of a multi-qubit register, according to another exemplary embodiment of the disclosure.

FIG. 7 schematically illustrates an edge-colored connectivity graph, which can be utilized to generate quantum circuits for preparing a superposed quantum state of n-qubit registers on the edge-colored connectivity graph, according to another exemplary embodiment of the disclosure.

FIGS. 8A, 8B, and 8C illustrate an exemplary process for generating a quantum circuit that is configured to prepare a superposed quantum state of a multi-qubit register using the edge-colored connectivity graph of FIG. 7, according to another exemplary embodiment of the disclosure.

FIGS. 9A, 9B, 9C, and 9D illustrate a process for generating a quantum circuit that is configured to prepare a quantum state of a multi-qubit register on a linear nearest-neighbor connected graph, according to an exemplary embodiment of the disclosure.

FIG. 10 schematically illustrates exemplary quantum circuits that are generated by performing the procedure of FIG. 9D, according to an exemplary embodiment of the disclosure.

FIGS. 11A, 11B, 11C, and 11D illustrate methods for preparing quantum states of multi-qubit registers on grid architectures, according to exemplary embodiments of the disclosure.

FIG. 12 schematically illustrates an exemplary architecture of a computing environment for hosting a quantum computing platform for synthesizing quantum circuits for preparing superposed states, according to an exemplary embodiment of the disclosure.

FIG. 13A is a schematic block diagram of an exemplary hybrid computing system that can facilitate execution of a quantum algorithm, according to an exemplary embodiment of the disclosure.

FIG. 13B is a schematic block diagram of an exemplary architecture, and data transmission, of a hybrid computation system employed using a cloud architecture for a classical backend, according to an exemplary embodiment of the disclosure.

### DETAILED DESCRIPTION

Exemplary embodiments of the disclosure will now be described in further detail with regard to techniques for synthesizing quantum circuits for quantum computations and, in particular, techniques for synthesizing quantum circuits for preparing superposed state. For example, various methods and solutions are provided to generate quantum circuits that are configured to prepare (initialize) superposition states of a quantum register comprising n qubits (e.g., n-qubit register) of the general form:

$$\vert ψ 〉 = \frac{1}{\sqrt{2}} \vert α 〉 + \frac{1}{\sqrt{2}} \vert β 〉 ,$$

where ket|α [symbol] and ket|β [symbol] represent different computational basis states over n qubits, i.e., |α [symbol] ≠|β [symbol] .

It is to be understood that the various features shown in the accompanying drawings are schematic illustrations that are not drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the term “exemplary” as used herein means “serving as an example, instance, or illustration.” Any embodiment or design described herein as “exemplary” is not to be construed as preferred or advantageous over other embodiments or designs.

Further, it is to be understood that the phrase “configured to” as used in conjunction with a circuit, structure, element, component, or the like, performing one or more functions or otherwise providing some functionality, is intended to encompass embodiments wherein the circuit, structure, element, component, or the like, is implemented in hardware, software, and/or combinations thereof, and in implementations that comprise hardware, wherein the hardware may comprise quantum circuit elements (e.g., quantum bits, coupler circuitry, etc.), discrete circuit elements (e.g., transistors, inverters, etc.), programmable elements (e.g., application specific integrated circuit (ASIC) chips, field-programmable gate array (FPGA) chips, etc.), processing devices (e.g., central processing units (CPUs), graphics processing units (GPUs), etc.), one or more integrated circuits, and/or combinations thereof. Thus, by way of example only, when a circuit, structure, element, component, etc., is defined to be configured to provide a specific functionality, it is intended to cover, but not be limited to, embodiments where the circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as cover embodiments when the circuit, structure, element, component, etc., is in a non-operational state (e.g., not connected nor otherwise deployed in a system, not powered on, not receiving an input, and/or not producing an output) or in a partial operational state.

As noted above, quantum computing provides a computing paradigm which utilizes fundamental principles of quantum mechanics to perform computations. Quantum circuits are utilized to define complex algorithms and applications in an abstract manner, which can be executed on a quantum computer. In a quantum computer, primitive operations comprise gate operations, e.g., single-qubit gate operations, two-qubit gate operations, multi-qubit gate operations (e.g., 3 or more qubits) that are applied to qubits, to perform quantum computing operations for a given application. A quantum computing system can be implemented using a superconducting quantum processor which comprises an array of superconducting qubits, such as transmon qubits, to generate and process quantum information.

Various types of quantum information processing operations (e.g., gate operations) can be performed in which superconducting qubits can be coherently controlled, placed into quantum superposition states (via, e.g., single-gate operations), exhibit quantum interference effects, and become entangled with one another (via, e.g., entanglement gate operations). In particular, quantum superposition is quantum-mechanical phenomena in which the quantum states of one or more qubits can superposed (i.e., added together) to produce another valid quantum state, wherein such quantum state can be represented as a sum of the two or more distinct states. Further, quantum entanglement is a quantum-mechanical phenomena in which a group of two or more qubits interact in such a way that the state of one qubit becomes intertwined with the states of the other qubits, wherein the quantum state of each qubit cannot be described independently (the quantum state is given for the group of entangled qubits as a whole).

Typically, quantum computing systems are configured to process quantum information that is encoded in a computational basis (|0 [symbol] or |1 [symbol] ) of the qubits, wherein gate operations are performed using the two lowest energy levels of a qubit including a ground state |0 [symbol] and a first excited state |1 [symbol] . A single qubit can have a basis state of |0 [symbol] or |1 [symbol] , or a superposition state which comprises a linear combination of such basis states |0 [symbol] or |1 [symbol] . In addition, quantum information can be encoded through entangled basis states of multiple qubits.

As is known in the art, the state of a qubit can be graphically represented as a point on unit sphere (radius=1), which is called the Bloch sphere, with X, Y, and Z axes. The basis state |0 [symbol] (referred to as ground state) of a qubit is represented at a point (north pole) on a positive Z-axis of the Bloch sphere, while the basis state or |1 [symbol] (referred to as first excited state) of a qubit is represented at a point (south pole) on a negative Z-axis of the Bloch sphere.

A superposition state |ψ [symbol] of the qubit can be represented as a point on the Bloch sphere as follows:

$$\vert ψ 〉 = cos \frac{θ}{2} \vert 0 〉 + {e}^{i ϕ} sin \frac{θ}{2} \vert 1 〉 ,$$

where the terms cos

$$\frac{θ}{2}$$

and sin

$$\frac{θ}{2}$$

correspond to the amplitude probabilities associated with the respective states |0 [symbol] and |1 [symbol] , and wherein the term e^{iϕ} corresponds to a relative phase between the states |0 [symbol] and |1 [symbol] . The position of a point on the Bloch sphere representing a superposition state of a qubit is determined based on the angles θ and ϕ. The angle θ represents the angle from the positive Z axis (the |0 [symbol] state) to the positive X axis on the X-Z plane, where 0≤θ≤π. The angle ϕ represents the angle from the positive X axis (the |+ [symbol] state) to the positive Y axis on the X-Y plane, where 0≤ϕ≤2π. The angle θ influences the probability of observing a qubit state of |0 [symbol] or | 1 [symbol] when the qubit is read, wherein the probability of reading a qubit state of | 1 [symbol] increases as θ increases. The angle ϕ influences the relative phase between the states |0 [symbol] and |1 [symbol] . The state of a given qubit can be changed by applying a single-qubit gate operation to the given qubit, which causes the current state of the qubit to rotate around, e.g., the X-axis, Y-axis, and/or Z-axis, etc., depending on the given gate operation. A rotation about the Z-axis results in a change in the angle ϕ.

As noted above, exemplary embodiments of the disclosure include systems and methods for generating quantum circuits that are configured to prepare (initialize) superposition states of a quantum register comprising n qubits (e.g., n-qubit register) of the form:

$$\vert ψ 〉 = \frac{1}{\sqrt{2}} \vert α 〉 + \frac{1}{\sqrt{2}} \vert β 〉 ,$$

where ket|α [symbol] and kept|β [symbol] represent different computational basis states over n qubits, i.e., |α [symbol] ≠|β [symbol] , and where measurement outcomes represented by ket|α [symbol] and ket|β [symbol] have equal (e.g., 50%) chances of being measured. For example, for a given qubit connectivity graph (qubit lattice), an exemplary target initialization superposition state of a quantum register comprising n=19 qubits can be of the form:

$$\vert ψ 〉 = \frac{1}{\sqrt{2}} \vert α 〉 + \frac{1}{\sqrt{2}} \vert β 〉 ,$$

where |α [symbol] =|0000000000000000000 [symbol] and where |β [symbol] =|1111111111111010101 [symbol] .

In some embodiments, exemplary methods for synthesizing quantum circuits are configured to utilize information such as, e.g., a target superposed quantum state, a connectivity graph representing a qubit lattice or portion of a qubit lattice of a given quantum processor, and an edge coloring of the connectivity graph, to generate a quantum circuit which is configured to prepare the target superposed state, while satisfying the following conditions:
(i) the gate set of the quantum circuit comprises arbitrary 1-qubit gates and 2-qubit controlled NOT gates (alternatively referred to as controlled-X gate, or CX-gates);
(ii) the quantum circuit adheres to the given connectivity graph, e.g., every CX-gate is over two qubits (vertices in the graph) connected by an edge;
(iii) the CX-gates of the quantum circuit are organized into CX-layers, wherein each CX-layer comprises sets of CX-gates that can be performed in parallel;
(iv) each CX-layer corresponds to one color of a plurality of colors used for edge coloring of the connectivity graph, that is, the set of edges corresponding to CX-gates of a given CX-layer is exactly the set of edges corresponding to one of the colors in the edge coloring (where the directionality of the CX-gates does not matter); and
(v) the number of CX-layers should be minimized.

In addition to the generalized superposed quantum state (general case:

$$\vert ψ 〉 = \frac{1}{\sqrt{2}} \vert α 〉 + \frac{1}{\sqrt{2}} \vert β 〉$$

for any α≠β, exemplary embodiments of the disclosure include techniques for generating quantum circuits for preparing superposed states of n-qubit registers for special quantum systems with special connectivity graphs and special superposed states including, but not limited, to Greenberger-Horne-Zeilinger (GHZ) states, checkerboard states, and controlled Hartree-Fock states.

In particular, a GHZ state is generally represented by |α [symbol] =|00 . . . 0 [symbol] and |β [symbol] =|11 . . . 1 [symbol] . For example, assuming a GHZ state comprises a quantum register comprising n=7 qubits, |α [symbol] =|0000000 [symbol] and |β [symbol] =|1111111 [symbol] . Moreover, a checkerboard state comprises quantum system with a quantum register having an odd number n of qubits, where |α [symbol] =|0000 . . . 00 [symbol] and |β [symbol] =|1010 . . . 01 [symbol] . For example, assuming a checkerboard state of a quantum system with a quantum register comprising n=7 qubits, |α [symbol] =|0000000 [symbol] and |β [symbol] =|1010101 [symbol] . Further, a controlled Hartree-Fock state comprises a quantum system with a quantum register having an odd number n of qubits, where |α [symbol] =|00 . . . 0 [symbol] and |β [symbol] =|b₁ . . . bₙ [symbol] with

$$\sum {b}_{i} = \frac{n + 1}{2} .$$

For example, assuming a controlled Hartree-Fock state of a quantum system with a quantum register comprising n=7 qubits, |α [symbol] =|0000000 [symbol] and |β [symbol] =|1100110 [symbol] .

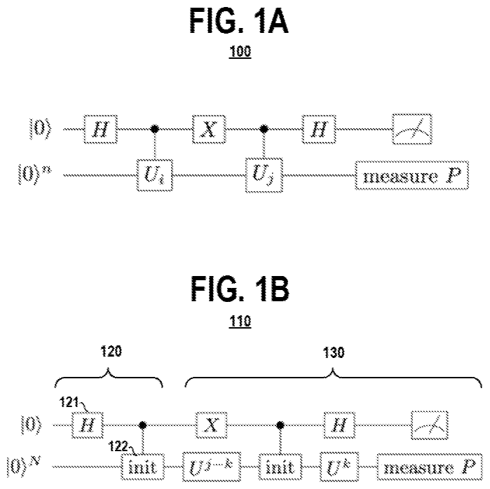

In some embodiments, the exemplary quantum state preparation circuits and techniques as disclosed herein are motivated by, e.g., the task of estimating ground state energies for many-body systems, while enabling advanced quantum error mitigation. In general, the exemplary quantum state preparation circuits and techniques described herein can be utilized for any state preparation task, including logical state preparation of quantum codes, and in conjunction with ground state energy estimation. Classically, estimating ground state energies of a quantum system has an exponential overhead, and quantum computation aims to increase the speeds of such tasks A well-established strategy for this estimation is to use the generalized eigenvalue problem, where a modified Hadamard test is used to measure matrix elements of the Hamiltonian ( [symbol] ψᵢ|H|ψⱼ [symbol] ) and the overlap matrix ( [symbol] ψᵢ|ψⱼ [symbol] ) using a quantum circuit 100 such as shown in FIG. 1A. The quantum circuit 100 of FIG. 1A can be modified to remove the need for controlled time evolutions, resulting in the quantum circuit 110 as shown in FIG. 1B.

The quantum circuit 110 of FIG. 1B comprises a first circuit portion 120 and a second circuit portion 130. The first circuit portion 120 is synthesized using exemplary quantum state preparation circuit techniques as disclosed herein, to generate a quantum circuit that is configured to prepare an initial (target) superposed quantum state for an n-qubit register. The second circuit portion 130 is configured for ground state energy estimation using the initial prepared superposed quantum state. The first circuit portion 120 comprises a Hadamard gate 121 that is applied to a given qubit to place the qubit register in a superposition state, and a controlled_init operation 121 which comprises layers of CX-gates to generate the desired initial state (init). For quantum chemistry problems, the initial state can be a Hartree-Fock state. Likewise, for certain quantum spin models, the initial state can be the checkerboard state |00 . . . 00 [symbol] +|0101 . . . 0101 [symbol] . The exemplary quantum state preparing circuits and techniques provide for CX-gate efficient and quantum error mitigation-compatible ways to prepare any such “controlled-state”.

To elaborate further, in some embodiments, the exemplary quantum state preparation circuits and techniques as disclosed herein are motivated by the need to employ advanced error mitigation methods, such as Probabilistic Error Cancellation (PEC) and Zero Noise Extrapolation (ZNE). Such mitigation methods require learning a noise-model for each unique CX-layer, and therefore require the quantum state preparation circuit to have a minimal number of unique CX-layers. Note that more unique CX-layers not only increase the runtime execution, such CX-layers also increase the risk of failure because the quantum noise of the quantum device may drift away from the learned noise model.

A possible approach is to fix, a priori, the set of allowed CX-layers, corresponding to an edge-coloring of the connectivity graph, which leads to synthesizing a quantum circuit that adheres to the edge-coloring. Another possible approach is not to fix the allowed CX-layers upfront, allowing them to depend on the circuit, which leads to the requirement to synthesize a quantum circuit with few unique CX-layers. The second requirement that the “depth” of the quantum circuit (or equivalently, the total number of CX-layers) must be as small as possible is motivated by the fact that 2-qubit gates are significantly noisier than 1-qubit gates, and hence additional layers of CX-gates increase the total noise.

Overall, the exemplary quantum circuit construction algorithms as described herein generate “controlled-Init” quantum circuits that are both depth-efficient and use a minimal number of unique CX-layers. This has a multiplicative effect on performance: it reduces the decoherence experienced during circuit execution, it allows error mitigation to increase algorithmic performance, and it reduces the total runtime by minimizing the number of required experiments.

In some embodiments, methods are provided for synthesizing quantum circuits that are configured to prepare general superposed states on general edge-colored connectivity graphs. Such methods generate a quantum circuit that comprises CX-layers which correspond to colors (or more generally, labels) in a given edge-colored connectivity graph, wherein a number of unique CX-layers does not exceed the total number of colors (or labels) of the given edge-colored connectivity graph. In some embodiments, a quantum circuit synthesis method is performed using a connectivity graph which comprises edges and vertexes in which each edge is assigned one label of a given set of unique labels such that no vertex of the connectivity graph is incident to two edges assigned with a same label. In the context of an edge-colored connectivity graph, an edge-coloring process can be implemented to assign colors to edges of the connectivity graph so that no two edges of the same color share a common vertex.

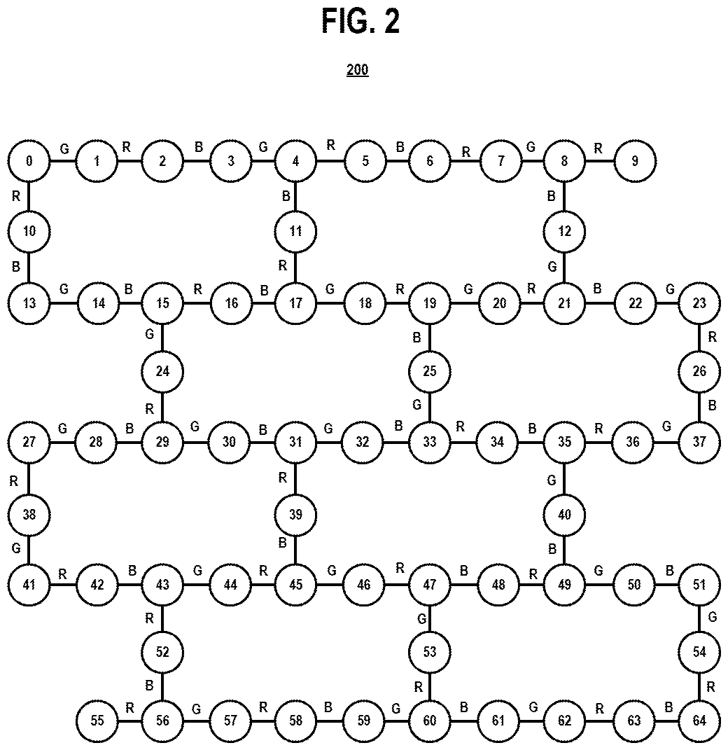

For example, FIG. 2 schematically illustrates an edge-colored connectivity graph, which can be utilized to generate quantum circuits for preparing a superposed quantum state of n-qubit registers on edge-colored connectivity graph, according to an exemplary embodiment of the disclosure. In particular, FIG. 2 schematically illustrates an edge-colored connectivity graph 200 which represents a heavy-hex connectivity graph of a multi-qubit device comprising 65 qubits (q₀, q₁, q₂, . . . , q₆₄) wherein each edge is colored using one of 3 colors, e.g., red R, blue B, and green G. As explained in further detail below, the exemplary edge-colored connectivity graph 200 can be used to generate quantum circuits comprising CX-layers corresponding to the colors of the edge coloring, e.g., a number of unique CX-layers does not exceed the number of different colors (e.g., 3 colors).

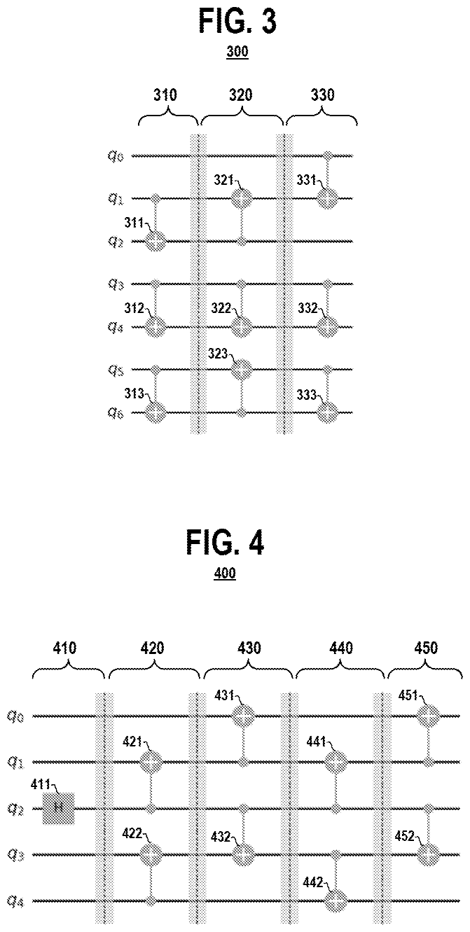

It is to be noted that two CX-layers are considered to be equivalent if the two CX-layers consist of the same CX-gates up to direction. For example, FIG. 3 schematically a quantum circuit comprising a plurality of unique CX-layers of a quantum state preparation circuit for preparing an initial superposed quantum state for an n-qubit register, according to an exemplary embodiment of the disclosure. In particular, FIG. 3 schematically illustrates a quantum circuit 300 comprising a first CX-layer 310, a second CX-layer 320, and a third CX-layer 330. The first CX-layer 310 comprises three CX-gates 311, 312, and 313. The second CX-layer 320 comprises three CX-gates 321, 322, and 323. The third CX-layer 330 comprises three CX-gates 331, 332, and 333. The quantum circuit 300 comprises a 7-qubit register (q₀, q₁, q₂, q₃, q₄, q₅, q₆).

The quantum circuit 300 comprises three CX-layers 310, 320 and 330, but only two unique CX-layers. In particular, the first and the second CX-layers 310 and 320 are equivalent because the first and second CX-layers 310 and 320 each comprise a set of CX-gates that are applied to the same qubit pairs (q₁, q₂), (q₃, q₄) and (q₅, q₆). On the other hand, the third CX-layer 330 comprises the CX-gate 331 that is applied to the qubit pair (q₀, q₁), while the first and second CX-layers 310 and 320 do not include such a CX-gate. It is to be noted that the directions of the CX-gates do not matter because it is possible to change the direction of a CX gate using single-qubit gates: CX(u, v)=H(u) H(v) CX(v, u) H(u) H(v), where H is the Hadamard gate.

In other embodiments, as explained in further detail below, exemplary methods are provided for synthesizing quantum circuits which are configured to prepare general superposed states on general connectivity graphs in circumstances where the edge coloring of a connectivity graph is not given. In such embodiments, a desired result is to construct a quantum circuit that prepares a given quantum state and minimizes both the number of CX-layers and the number of unique CX-layers.

Furthermore, with regard to connectivity graphs, exemplary methods are provided for synthesizing quantum circuits which are configured to prepare superposed quantum states on any type of connected graph, and in specific types of connected graphs including, e.g., tree connectivity, linear nearest-neighbor (LNN) connectivity, and grid connectivity. In the case of LLN connectivity, the qubits are organized in a line, with every qubit connected to the one to its immediate left and the one to its immediate right. In the case of grid connectivity, the qubits are organized in a grid, with every qubit connected to the ones to its left, to its right, above it and below it.

In the following detailed description, the following notations are utilized. The vertices of a given graph G are denoted using letters, e.g., u, v, w, x, y, etc., and the edges of the given graph G are denoted using tuples of vertices (u, v), (v, w), etc. The term CX(u, v) denotes a CX-gate (also called controlled-NOT gate) with control qubit u and target qubit v. A “superposed quantum state” refers to a quantum state of the form to

$$\frac{1}{\sqrt{2}} \vert α 〉 + \frac{1}{\sqrt{2}} \vert β 〉 .$$

The term state refers to a vector of 0s and 1s. For example,

$$\frac{1}{\sqrt{2}} \vert 00000 〉 + \frac{1}{\sqrt{2}} \vert 10101 〉$$

is a superposed quantum state, while 00000 and 10101 are states. The term “depth” with regard to a quantum circuit with CX-gates refers to a total number of CX-layers. For example, in FIG. 3, the quantum circuit 300 has a depth of 3. The term “density” with regard to a quantum circuit refers to a ratio between the number of gates in the quantum circuit and the maximum number of gates of a quantum circuit of the given depth.

In some embodiments, exemplary techniques include two algorithms that prepare a general superposed state on a general edge-colored connectivity graph. The two algorithms produce quantum circuits that consist of CX-layers corresponding to colors in the edge-coloring, and in particular the number of unique layers does not exceed the total number of colors. The first algorithm, denoted state_prepaparation_backwards, is presented due to its simplicity, and a second algorithm, denoted state_preparation, is configured to generate quantum circuits with precise upper bounds on depth. Furthermore, the state_preparation algorithm is described in the context of a special case wherein a connectivity graph is a tree, leading to improved upper bounds on circuit depth.

Moreover, in some embodiments, the exemplary techniques include an algorithm to prepare a general superposed state on a general connectivity graph in the case that the edge-coloring is given. The algorithm requires at most K unique CX-layers, where K is a maximum degree of the given connectivity graph.

Furthermore, in some embodiments, specialized algorithms are provided for LNN connectivity over n qubits. In such cases, a state preparation process can be achieved with a depth≈n/2, and two unique CX-layers, leading to a density=1. More specifically, for LNN connectivity, an exemplary algorithm is configured to prepare a general superposed state of the form

$$\frac{1}{\sqrt{2}} \vert α 〉 + \frac{1}{\sqrt{2}} \vert β 〉 ,$$

where α, β∈{0,1}ⁿ, in depth of n/2+4=k+4 for even n (n=2k), and in depth of (n+1)/2+4=k+5 for odd n (n=2k+1).

In addition, special use cases of the exemplary algorithms are provided for (i) GHZ states in depth k+4 for n odd (n=2k+1), and (ii) checkerboard states in depth k+3 for n odd (n=2k+1). Further, an improved algorithm to is provided to prepare GHZ states: (i) in depth 2 for k=1, (ii) in depth k+2 for 2≤k≤4, and (iii) in depth k+1 for k≥5.

A summary of these results, as well as specific depths for small values of n, are given in the following Table. The Table illustrates depths of state preparation circuits for linear nearest-neighbor connectivity with 2 unique layers for general superposed states, as well as GHZ and checkerboard states.

| | | general | GHZ | checkerboard |
|---|---|---|---|---|
| N | K | states | states | states |
| 4 | 2 | 6 | | |
| 5 | 2 | 7 | 4 | 5 |
| 6 | 3 | 7 | | |
| 7 | 3 | 8 | 5 | 6 |
| 8 | 4 | 8 | | |
| 9 | 4 | 9 | 6 | 7 |
| 10 | 5 | 9 | | |
| 11 | 5 | 10 | 6 | 8 |
| 12 | 6 | 10 | | |
| 13 | 6 | 11 | 7 | 9 |
| n = 2k even | k | k + 4 | 2 for k = 1 | k + 2 |
| n = 2k + 1 odd | k | k + 5 | k + 2 for 2 ≤ k ≤ 4 | |
| | | | k + 1 for k >= 5 | |

Furthermore, specialized algorithms are provided to for n×n grids: (i) an algorithm to prepare a general superposed state in depth O(n²) with 2 unique layers; (ii) an algorithm to prepare a general superposed state in depth O(n) with 4 unique layers, and (iii) an algorithm to prepare a general superposed state in depth O(n) with 3 unique layers.

In preparing a quantum superposition state of the form:

$$\vert ψ 〉 = \frac{1}{\sqrt{2}} \vert α 〉 + \frac{1}{\sqrt{2}} \vert β 〉 ,$$

the problem can be reduced to the case where α=0, by appending a layer of X-gates at the end of the quantum state preparation circuit. As is known in the art, an X gate applied to a given qubit will flip (invert) the state of the qubit between the ground |0 [symbol] and first excited |1 [symbol] states, or flip a superposition of the |0 [symbol] and |1 [symbol] states. In other words, an X gate instruction performs a quantum state-inverting gate operation (or quantum X gate operation) that is configured to flip a state a quantum bit in a computational state spanned by a ground state |0 [symbol] and a first excited state |1 [symbol] .

For example, for a 5-qubit register (e.g., qubits q₀, q₁, q₂, q₃, q₄, and q₅), assume that a target superposition state of the 5-qubit register is

$$\vert ψ 〉 = \frac{1}{\sqrt{2}} \vert 00000 〉 + \frac{1}{\sqrt{2}} \vert 10101 〉 .$$

Applying an X-gate to the second qubit (q₁) and to the third qubit (q₂) brings the state|01100 [symbol] to |00000 [symbol] , and brings the state |11010 [symbol] to |10110 [symbol] (based on the fact that applying a quantum gate to a register will apply the gate to every term in the superposition of the register, independently). In other words, applying the X-gate to the second qubit (q₁) and to the third qubit (q₂) results in a superposition state of

$$\vert ψ 〉 = \frac{1}{\sqrt{2}} \vert 00000 〉 + \frac{1}{\sqrt{2}} \vert 10101 〉 .$$

In this regard, constructing a quantum circuit that is configured to prepare the superposition state of

$$\vert ψ 〉 = \frac{1}{\sqrt{2}} \vert 00000 〉 + \frac{1}{\sqrt{2}} \vert 10101 〉$$

(where α=0), and appending X-gates on the second qubit (q₁) and the third qubit (q₂), results in a quantum preparation circuit that is configured to prepare the target superposition state of the 5-qubit register as

$$\vert ψ 〉 = \frac{1}{\sqrt{2}} \vert 00000 〉 + \frac{1}{\sqrt{2}} \vert 10101 〉 .$$

In the following description of exemplary embodiments, it is assumed that α=0.

In some embodiments, quantum circuit synthesis methods are configured to construct a quantum state preparation circuit for preparing a superposed quantum state of a multi-qubit register, wherein the quantum state preparation circuit comprises a single Hadamard gate (H-gate) followed by a sequence of layers of CX-gates, which allows simplification of the state preparation process. For example, FIG. 4 schematically illustrates a quantum circuit for preparing a superposed quantum state of a multi-qubit register, according to an exemplary embodiment of the disclosure. In particular, FIG. 4 schematically illustrates a quantum circuit 400 for preparing a superposed quantum state of a multi-qubit register comprising five qubits |q₀ q₁ q₂ q₃ q₄ [symbol] . The exemplary quantum circuit 400 comprises a plurality of layers including an initial layer 410 which comprises a Hadamard gate 411, and a plurality of CX-layers 420, 430, 440, and 450. The CX-layer 420 comprises CX-gates 421 and 422. The CX-layer 430 comprises CX-gates 431 and 432. The CX-layer 440 comprises CX-gates 441 and 442. The CX-layer 450 comprises CX-gates 451 and 452.

The quantum circuit 400 converts the 5-qubit register with an initial state of |00000 [symbol] into a superposed checkerboard state

$$\vert ψ 〉 = \frac{1}{\sqrt{2}} \vert 00000 〉 + \frac{1}{\sqrt{2}} \vert 10101 〉 .$$

In particular, the quantum circuit 400 operates as follows. Assume the quantum circuit 400 starts with the five-qubit register |q₀ q₁ q₂ q₃ q₄ [symbol] in the quantum state |00000 [symbol] . In the initial layer 410, the Hadamard gate 411 is applied to the qubit q₂, which places the qubit register into a superposition state of

$$\vert ψ 〉 = \frac{1}{\sqrt{2}} \vert α 〉 + \frac{1}{\sqrt{2}} \vert β 〉$$

where |α [symbol] =|00000 [symbol] and |β [symbol] =|00100 [symbol] . Each consecutive gate CX(u,v) maintains the quantum state in the superposition of two states. In particular, each consecutive gate CX(u,v) does not change |α [symbol] , but changes |β [symbol] by adding the value of the control qubit u to the value of target qubit v mod 2. In such instance, only the second component |β [symbol] of the superposed state needs to be tracked. In the following description, the second component |β [symbol] is denoted by state S.

In the quantum circuit 400, after applying the Hadamard gate 411, the state S is 00100. In the first CX-layer 420, the CX-gate 421 is applied between the qubit q₂ (control) and the qubit q₁ (target), and the CX-gate 422 is applied between the qubit q₄ (control) and the qubit q₃ (target). As noted above, a CX-gate operates to conditionally flip the state of the target qubit based on the state of the control qubit, i.e., the state of the target qubit is flipped when the control qubit has a “1” state. In this regard, after applying the first CX-layer 420 to the superposed qubit register, the state S changes from 00100 to 01100, while a remains 00000. In particular, applying the CX-gate 421 performs the following operations: CX(2,1) |00000 [symbol] and CX(2,1) |00100 [symbol] , and CX-gate 422 performs the following operations: CX(4,3) |00000 [symbol] and CX(4,3) |00100 [symbol] . As a result, a remains |00000 [symbol] and |β [symbol] is |01100 [symbol] , where S=01100.

In the second CX-layer 430, the CX-gate 431 is applied between the qubit q₁ (control) and the qubit q₀ (target) (i.e., CX(1,0) |00000 [symbol] and CX(1,0) |01100 [symbol] ), and the CX-gate 432 is applied between the qubit q₂ (control) and the qubit q₃ (target) (i.e., CX(2,3) |00000 [symbol] and CX(2,3) |01100 [symbol] ). As a result of the second CX-layer 430, the state S changes from 01100 to 11110.

In the third CX-layer 440, the CX-gate 441 is applied between the qubit q₂ (control) and the qubit q₁ (target) (i.e., CX(2,1) |00000 [symbol] and CX(2,1) |11110 [symbol] ), and the CX-gate 442 is applied between the qubit q₃ (control) and the qubit q₄ (target) (i.e., CX(3,4) |00000 [symbol] and CX(3,4) |11110 [symbol] ). As a result of the third CX-layer 440, the state S changes from 11110 to 10111.

In the fourth CX-layer 450, the CX-gate 451 is applied between the qubit q₁ (control) and the qubit q₀ (target) (i.e., CX(1,0) |00000 [symbol] and CX(1,0) |10111 [symbol] ), and the CX-gate 452 is applied between the qubit q₂ (control) and the qubit q₃ (target) (i.e., CX(2,3) |00000 [symbol] and CX(2,3) |10111 [symbol] ). As a result of the fourth CX-layer 450, the state S changes from 10111 to 10101. In this instance, the final state of the 5-qubit register is a superposed checkerboard state

$$\vert ψ 〉 = \frac{1}{\sqrt{2}} \vert 00000 〉 + \frac{1}{\sqrt{2}} \vert 10101 〉 .$$

In view of the above, a quantum state preparation process can be generalized as follows with regard to a given graph G with n vertices. A state S is a vector of 0s and 1s of length n, wherein S[i] denotes the i^{th} element of the vector (where i=0, 1, 2, 3, . . . , n−1). Assume that state SF denotes a target quantum state to prepare. The process selects an index h (which corresponds to the location of the Hadamard gate) and a sequence of CX-gates, with the CX-gates organized into CX-layers adhering to the given connectivity and edge-coloring constraints. For example, in the exemplary quantum circuit 400 of FIG. 4 where n=5, the index h is 2 (corresponding qubit q₂). Let state S be initially defined to have a single 1 at the location (index h) of the Hadamard gate. Each CX(u,v)-gate updates S by adding S[u] to S[v] modulo 2. At the end of quantum state preparation process, S=SF.

When synthesizing circuits with respect to a given edge-coloring, a part of the problem is to make sure that each CX-layer contains all edges of the given color, i.e., without missing any edges. This can be partially solved by adding the missing gates CX(u, v) provided that S[u]=0, since such gates do not change the state S. Such CX-gates are referred to herein as “dummy” CX-gates. In the exemplary quantum circuit 400, the CX-gate 422 (i.e., CX(4,3)) in the first CX-layer 420 is a dummy CX-gate, because at the time of the first CX-layer 420, the state of the qubit q₄ is 0 (i.e., S[4]=0). Conversely, removing dummy gates from a quantum circuit does not change the final state. However, a missing CX(u, v) gate cannot be added, when both S[u]=1 and S[v]=1.

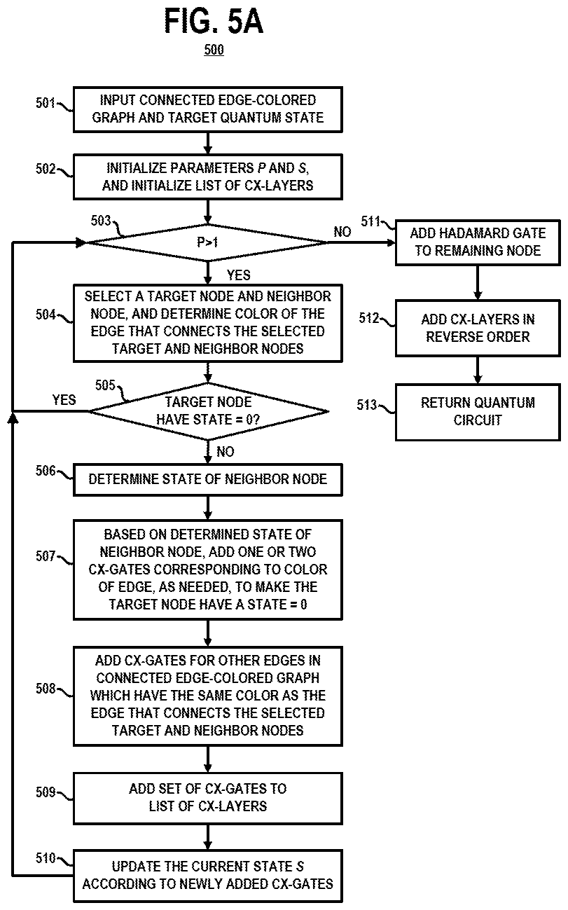

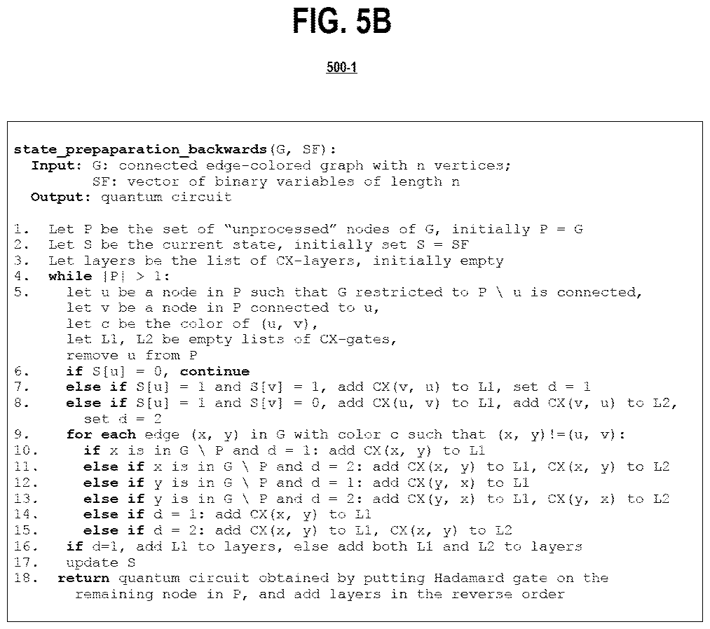

As noted above, exemplary embodiments of the disclosure include various methods for preparing a general superposed quantum state on a general edge-colored connectivity graph. Such methods are configured to produce quantum circuits which comprise CX-layers corresponding to colors in the edge-colored graph, wherein a number of unique CX-layers does not exceed the total number of colors. With such methods, the edge coloring of the connectivity graph is essentially the same as choosing the structure of unique CX-layers upfront. FIGS. 5A and 5B illustrate an exemplary process for generating a quantum circuit that is configured to prepare a superposed quantum state of a multi-qubit register, according to an exemplary embodiment of the disclosure. In particular, FIG. 5A illustrates a flow diagram of a method 500 for generating a quantum circuit for generating a superposed quantum state of a multi-qubit register, wherein the method 500 starts with a desired superposed quantum state and edge-colored node connectivity graph, and performs a backwards process to construct CX-layers of the quantum circuit until reaching a quantum state with a single “1”. FIG. 5B illustrates a block of pseudocode 500-1, which provides additional details of the exemplary quantum circuit generation process of FIG. 5A, according to an exemplary embodiment of the disclosure.

Referring to FIG. 5A, the exemplary method 500 includes an initial step of receiving as input a connected edge-colored graph G with n vertices (corresponding to a n-bit qubit register) and a target quantum state SF which comprise a vector of binary variables of length n (block 501). The process initializes a plurality of parameters (block 502). For example, in some embodiments, as shown in lines 1, 2, and 3 of the pseudocode 500-1 of FIG. 5B, the process (i) initializes a parameter P which represents a set of “unprocessed” nodes of G, wherein P is initially set to P=G, (ii) initializes a parameter S which represents a current state, wherein S is initially set to S=SF, and (iii) initializes a list, denoted Layers, which tracks a list of CX-layers, where Layers is initially an empty list.

The method 500 performs a while-loop which performs an iterative process (blocks 503 through 510) to generate a plurality CX-layers with CX-gates for constructing a quantum circuit, while keeping track of set of unprocessed nodes P to determine when there remains a single unprocessed node (block 503). The iterative process continues while the number of unprocessed nodes P is greater than one (affirmative determination in block 503), and the iterative process terminates when the number of unprocessed nodes P reaches one (negative determination in block 503).

For each iteration, the process selects an unprocessed target node u and an unprocessed neighbor node v, and determines a color of the edge (u, v) that connects the selected target and neighbor nodes (block 504). In some embodiments, the process selects an unprocessed target node u and an unprocessed neighbor node v on a condition that removing the unprocessed target node u does not make the remaining portion of the graph disconnected. In addition, the process initializes a first list of CX-gates, denoted L1, and a second list of CX-gates, denoted L2, wherein the first and second lists L1 and L2 are initially empty lists. Further, the target node u is marked as “processed” and, thus, removed from the set of unprocessed nodes P. In some embodiments, the process steps that are implemented in block 504 correspond to the description of the steps in line 5 of the pseudocode 500-1 of FIG. 5B.

The process continues by determining the state (value) of the target node u (block 505). If the target node u has a state=0 (affirmative determination in block 505), the process returns to the decision block 503, wherein the next iteration is performed if the number of unprocessed nodes P is greater than one (affirmative determination in block 503). On the other hand, if the target node u does not have a state=0 (negative result in block 505), in which case the target node u has a state=1, the process continues to determine the state of the selected neighbor node v (block 506). Depending on the determined state of the selected neighbor node v, the process will proceed to add either one or two CX-gates corresponding to the color of the edge color of the edge (u, v), as needed, to make the target node u have a state=0 (block 507).

More specifically, in some embodiments, if the selected neighbor node v has a state =1 (i.e., if S[u]=1 and S[v]=1), a single gate CX(v, u) is added to the first list L1 of CX-gates, and a parameter d is set as d=1. On the other hand, if the selected neighbor node v has a state=0 (i.e., if S[u]=1 and S[v]=0), two gates CX(u, v) and CX(v, u) are added, wherein CX(u, v) is added to the first list L1 of CX-gates, and CX(v, u) is added to the second list L2 of CX-gates, and the parameter d is set as d=2. In some embodiments, the process steps that are implemented in block 507 correspond to the description of the steps in lines 7 and 8 of the pseudocode 500-1 of FIG. 5B.

Next, the process continues by adding CX-gates for every other edge (x, y) in the connected edge-colored graph G which has the same color c of the edge (u, v) that connects the selected target and neighbor nodes (block 508). When either node x or node y is already processed, the process simply adds the edge from the already processed node to the other node, which does not change the state S since processed nodes have a state (value) of 0. If both nodes x and y are non-processed, it does not matter which edges are added. In some embodiments, the process steps that are implemented in block 508 correspond to the description of the steps in lines 9-15 of the pseudocode 500-1 of FIG. 5B. In particular, for each edge (x, y) between nodes x and y in the connected edge-colored graph G with color c where the edge (x, y) is not the edge (u, v) (line 9 of pseudocode 500-1), the following conditional process steps are performed:
(i) if the node x is already processed and d=1, then a gate CX(x, y) is added to the first list L1 of CX-gates (line 10);
(ii) else if the node x is already processed and d=2, then a gate CX(x, y) is added to the first list L1 of CX-gates, and a gate CX(x, y) is added to the second list L2 of CX-gates (line 11);
(iii) else if the node y is already processed and d=1, then the gate CX(y, x) is added to the first list L1 of CX-gates (line 12);
(iv) else if the node y is already processed and d=2, then a gate CX(y, x) is added to the first list L1 of CX-gates, and a gate CX(y, x) is added to the second list L2 of CX-gates (line 13);
(v) else if the nodes x and y are not processed and d=1, then a gate CX(x,y) is added to the first list L1 of CX gates (line 14); and
(vi) else if the nodes x and y are not processed and d=2, then a gate CX(x,y) is added to the first list L1 of CX gates, and a gate CX(x,y) is added to the second list L2 of CX gates (line 15).

After the lists L1 and L2 with associated sets of CX-gates are generated, the lists L1 and L2 of CX-gates are added to the list of CX-layers (block 509). More specifically, if d=1 for the given iteration, then the first list L1 of CX-gates are added to the list of CX-layers. On the other hand, if d=2 for the given iteration, then both lists L1 and L2 of CX-gates are added to the list of CX-layers (see, line 16 of pseudocode 500-1). The current state S is updated according to the newly added CX-gates (block 510), which completes the given iteration. After each iteration, the state of the selected target node u for the given iteration will become 0, and will remain 0 until the process completes.

After the completion of multiple iterations, the while-loop (blocks 503-510) terminates when it is determined that there remains a single unprocessed node, i.e., P=1 (negative determination in block 503), which indicated the location of the Hadamard gate. The process proceeds to generate the quantum circuit by adding a Hadamard gate to the remaining node (block 511), and adding the CX-layers to the quantum circuit in reverse order (block 512), and then returning the completed quantum circuit (block 513), as specified in line 18 of pseudocode 500-1. In an alternate embodiment, the method 500 of FIG. 5A can be modified by treating multiple edges of the same color in parallel.

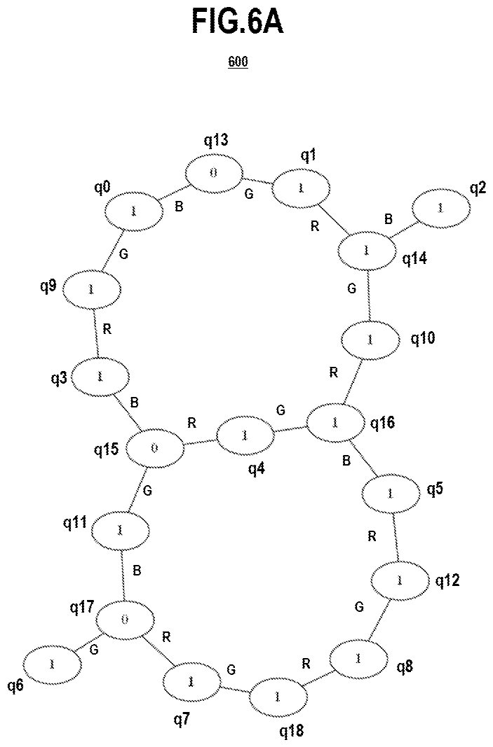

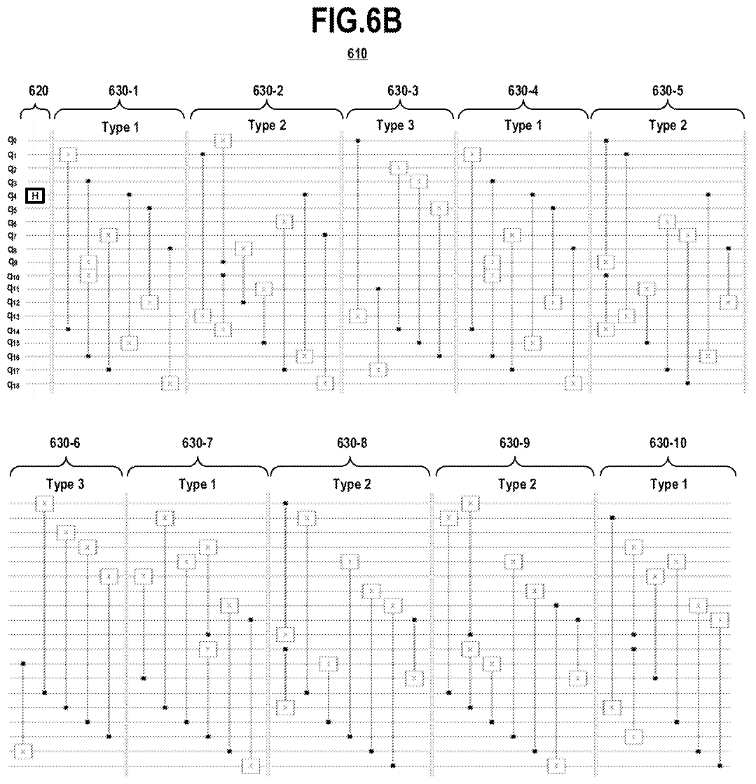

FIGS. 6A and 6B illustrate an exemplary process for generating a quantum circuit that is configured to prepare a superposed quantum state of a multi-qubit register, according to another exemplary embodiment of the disclosure. In particular, FIG. 6A illustrates an edge-colored connectivity graph 600 comprising 19 nodes that represent qubits (q₀, q₁, q₂, . . . , q₁₈), wherein the 19-qubit register comprises an exemplary target initialization superposition state of a quantum register comprising n=19 qubits can be of the form:

$$\vert ψ 〉 = \frac{1}{\sqrt{2}} \vert α 〉 + \frac{1}{\sqrt{2}} \vert β 〉$$

where |α [symbol] =|0000000000000000000 [symbol] and where |β [symbol] =|1111111111111010101 [symbol] . In FIG. 6A, the state of the 19 qubits is represented by the state |β [symbol] =|1111111111111010101 [symbol] . The edge-colored connectivity graph 600 comprise edges that are colored with one of three different colors, red R, blue B, and green G.

FIG. 6B illustrates a quantum circuit 610 that is configured to generate the state 18th |β [symbol] =|1111111111111010101 [symbol] with the 19-qubit register having input of |0000000000000000000 [symbol] . The quantum circuit 610 comprises an initial layer 620 comprising a Hadamard gate applied to q₄, and a sequence of CX-layers 630-1, 630-2, 630-3, 630-4, 630-5, 630-6, 630-7, 630-8, 630-8, 630-9, and 630-10. The quantum circuit 610 comprises a depth of 10, and comprises three unique CX-layers of Type 1, Type 2, and Type 3, which corresponds to the number of colors (3 colors) used for coloring the edges of the connectivity graph of FIG. 6A.

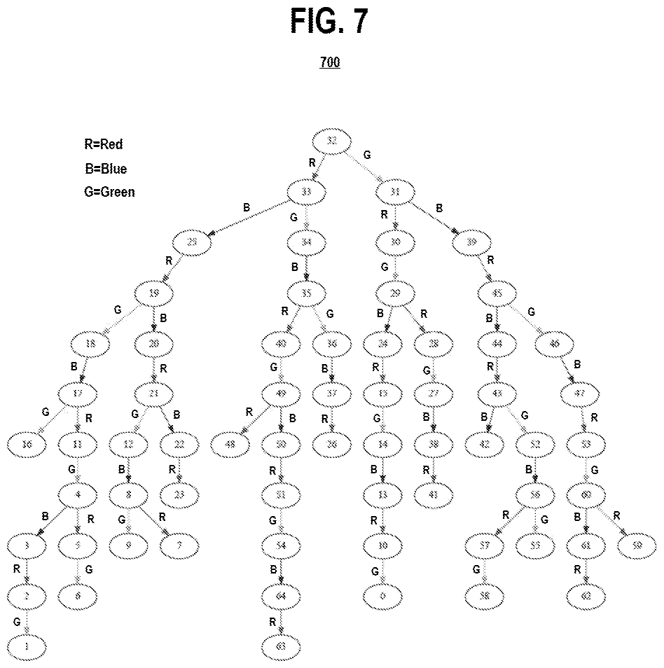

While FIGS. 5A and 5B illustrate an exemplary “backward” process for generating a quantum circuit that is configured to prepare a superposed quantum state of a multi-qubit register, other embodiments include a “forward” process for generating a quantum circuit that is configured to prepare a general superposed quantum state of a multi-qubit register on a general edge-colored connectivity graph. For illustrative purposes, an exemplary “forward” process for generating a quantum circuit will be discussed in the context of FIG. 7 which illustrates an edge-colored connectivity graph of a plurality of nodes which represent qubits, according to an exemplary embodiment of the disclosure. In particular, FIG. 7 illustrates an edge-colored connectivity graph 700 which comprises 65 nodes (e.g., node 0 through node 64) arranged in a tree structure. The edge-colored connectivity graph 700 comprises a root node, e.g., node 32, with edges colored with one of three (K=3) different colors, red (R), blue (B) or green (G).

In some embodiments, a depth-efficient “forward” algorithm for quantum state preparation is implemented using a connected, edge-colored graph G, with one of the nodes chosen to be a root node, wherein K denotes a number of colors, where the colors are labeled as {0, . . . , k-1}. As noted above, a state S is an assignment of a value of 0 or 1 to every node in the graph. A state S is deemed to be “sparse” if no two connected vertices (nodes) of G are assigned to 1. Equivalently, a state S is deemed to be “sparse” if for every edge (u, v) in G, either S[u]=0 or S[v]=0. Assume SF denotes a target state to be prepared. An exemplary “forward” process comprises two steps: (i) reducing SF to a sparse state SP, and (ii) preparing the sparse state SP.

In some embodiments, a process for reducing a target state SF to a sparse state SP using given unique layers generally proceeds as follows. The edge colors are considered one by one. For each edge (u, v) of a given color, if both nodes u and v have a value (state) of S=1, the process will generate a CX-gate, either CX(u, v) or CX(v, u). On the other hand, if either node u or node v has a value (state) of S=0, a “dummy” CX-gate is generated, wherein the control qubit is assigned to the node with S=0. After iterating through every color, there will exist no edge that connects two nodes having S=1, hence the resulting state SP is guaranteed to be sparse. To go back from SP to SF, the process needs to revert the order of layers.

A sparse state SP can be constructed using a process which assumes that the connected, edge-colored graph is a tree, in other embodiments, the process can be extended to general graphs. For now, an exemplary process for constructing a sparse state SP will be described in further detail, where it is assumed that the connected, edge-colored graph comprises a tree structure, such as shown in FIG. 7. The process fixes a cyclic ordering of the K colors, for instance 0, 1, . . . , K−1 (e.g., cyclic ordering of 0, 1, 2 in the edge-colored connectivity graph 700 of FIG. 7 where K=3). The process iteratively defines for each edge a “colored” depth in the edge-colored connectivity graph, as follows. First, a given edge that connects the root of the tree to a child of the root has a depth that is equal to the color of the given edge. Second, consider an edge (u, v) that connects an internal node u of the tree to a child node v, and assume that c denotes the color of the edge, and that q denotes the depth of the edge from u to its parent. The depth of the edge (u, v) is defined as the smallest integer that is larger than q and equals to c modulo K. With this process, all edges of the same color have depths with the same remainder modulo K. Furthermore, assume M denotes a maximal depth of an edge, and that a given node is deemed to be “used” if either the given node has a state S=1 in SP or if one of its recursive descendants has a state S=1 in SP.

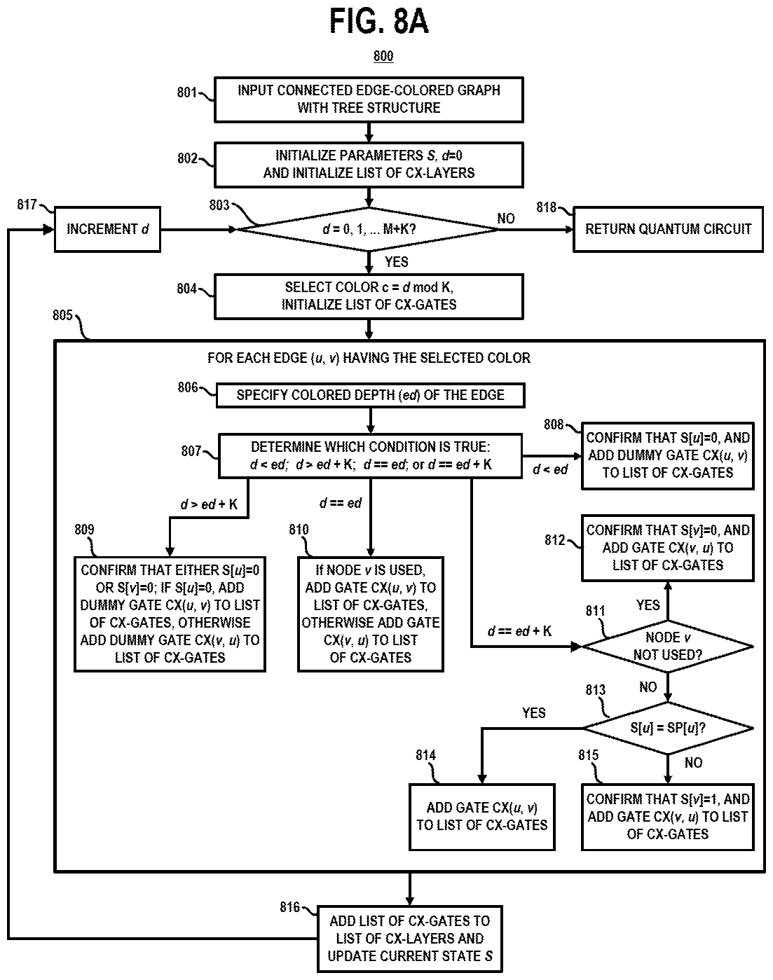

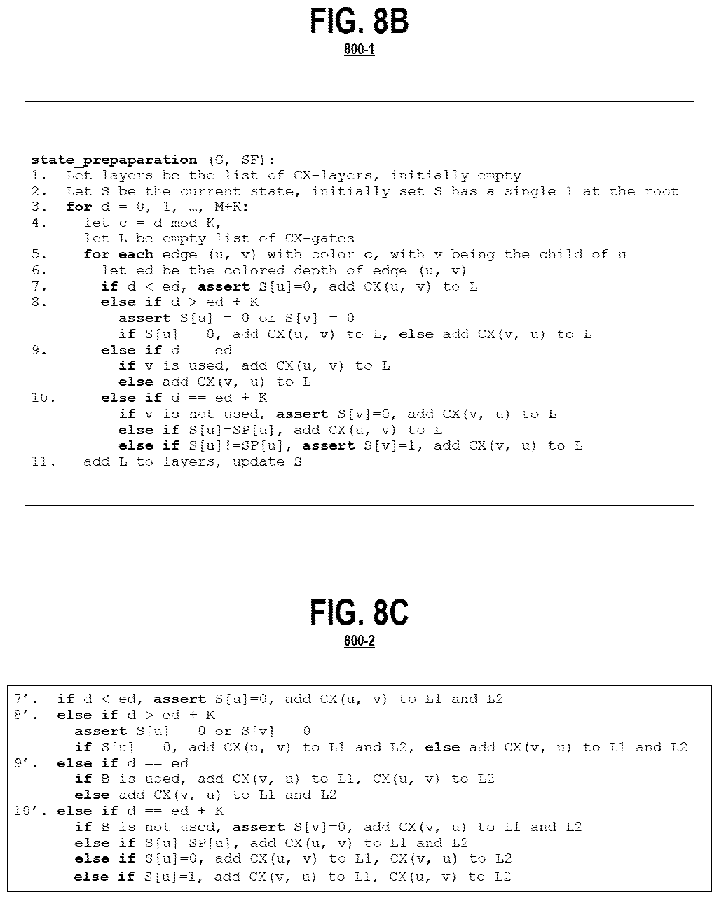

FIGS. 8A and 8B illustrate an exemplary process for generating a quantum circuit that is configured to prepare a quantum state of a multi-qubit register, according to another exemplary embodiment of the disclosure. In particular, FIG. 8A illustrates a flow diagram of an exemplary quantum circuit generation process 800 which implements a forward process for generating a quantum circuit for preparing a sparse quantum state on an edge-colored connectivity graph having a node tree structure. FIG. 8B illustrates a block of pseudocode 800-1, which provides additional details of the exemplary quantum circuit generation process of FIG. 8A, according to an exemplary embodiment of the disclosure.

FIG. 8A illustrates an exemplary quantum circuit generation process 800 for constructing a sparse state SP using M+K+1 layers of an edge-colored tree graph by following a fixed cyclic ordering of K colors of the colored edges. The exemplary quantum circuit generation process 800 includes an initial step of receiving as input a connected edge-colored graph G and a target quantum state SF (block 801). The process initializes a plurality of parameters (block 802). For example, in some embodiments, as shown in lines 1 and 2 of the pseudocode 800-1 of FIG. 8B, the process (i) initializes a parameter S which represents a current state, wherein S is initially set to have a value of 1 at the root node of the connected edge-colored graph, and (ii) initializes a list, denoted Layers, which tracks a list of CX-layers, where Layers is initially an empty list.

The quantum circuit generation process 800 executes a “for loop” to iterate through a sequence of values of d=0, 1, . . . , M+K (block 803), where a given value of d denotes an index of a CX-layer. In particular, for the initial iteration, the process initializes the value d=0, and selects a given color c for processing as c=d mod K, and initializes a list L of CX-gates, which is initially an empty list (block 804). It is to be noted that blocks 803 and 804 correspond to the lines 3 and 4 of the pseudocode 800-1 of FIG. 8B.

Then, for the given d and given color c, the process executes a nested “for loop” (block 805) for each edge (u, v) with color c (where node v is a child of node u), to generate CX-gates for the given iteration for d and c. The nested “for loop” (block 805) comprises a process (blocks 806-816) that is performed to add CX-gates so that all edges of the given color are included in a given CX-layer. It is to be noted that blocks 805-816 of FIG. 8A correspond to lines 5-10 of the pseudocode 800-1 of FIG. 8B.

Initially, for a given edge (u, v) with color c, the process specifies a colored depth (denoted, ed) of the given edge (u, v) (block 806). Then, for the given edge (u, v) with the color c and the colored depth ed, the process determines which of the following four conditions are true: (i) d<ed; (ii) d >ed+K, (iii) d==ed, or (iv) d==ed+K (block 807). If it is determined that d <ed, the process proceeds to confirm that S[u]=0 (state of node u is 0) and then adds a dummy gate CX(u, v) to the list L of CX-gates (block 808). If it is determined (in block 807) that d >ed +K, the process proceeds to confirm that either S[u]=0 or that S[v]=0, and if S[u]=0, a dummy gate CX(u, v) is added to the list L of CX-gates, otherwise a dummy gate CX(v, u) is added to the list L of CX-gates (block 809). It is to be noted that block 809 corresponds to the line 8 of the pseudocode 800-1 of FIG. 8B. If it is determined (in block 807) that d==ed, if node vis “used,” a gate CX(u, v) is added to the list L of CX-gates, otherwise a gate CX(v, u) is added to the list L of CX-gates (block 810). It is to be noted that block 810 corresponds to the line 9 of the pseudocode 800-1 of FIG. 8B.

If it is determined (in block 807) that d==ed+K, a determination is made as to whether node v is “not used” or “used” (block 811). If it is determined that node v is “not used” (affirmative determination in block 811), the process proceeds to confirm that S[v]=0, and adds a gate CX(v, u) to the list L of CX-gates (block 812). If it is determined that node v is “used” (negative determination in block 811), the process proceeds to determine whether S[u]=SP[u] or S[u]!=SP[u] (block 813). If it is determined that S[u]=SP[u] (affirmative determination in block 813), a gate CX(u, v) is added to the list L of CX-gates (block 814). On the other hand, if it is determined that S[u]!=SP[u] (negative determination in block 813), the process proceeds to confirm that S[v]=1, and adds a gate CX(v, u) to the list L of CX-gates (block 815). It is to be noted that blocks 811, 812, 813, 814, and 815 correspond to line 10 of the pseudocode 800-1 of FIG. 8B.

After completion of the nested “for loop” (block 805) in which all edges (u, v) with the selected color c for the given iteration d, the process proceeds to add the list L of CX-gates to the list of CX-layers, and update the state S (block 816). The value of d is incremented (block 817), and the process (blocks 804 and 805) is repeated for the next value of d. When the last iteration is complete, and d is incremented to a value in which d >M+K (negative condition in block 803), the process proceeds to construct and return the quantum circuit using the determined CX-layers (block 818).

It is to be noted that intuitively, the process of FIGS. 8A and 8B implements a “two-waves” approach to create a sparse state SP starting from the initial state with a single 1 at the root of the tree. In particular, a first wave spreads along all edges of the tree, propagating the value 1 from the root node to every “used” child node. In the pseudocode 800-1 of FIG. 8B, the first wave corresponds to line 9 when the given layer d is equal to the colored depth ed of a given edge (u, v) being examined. After applying the first wave, every “used” node will have a value of 1 and every “unused” node will have a value of 0. Further, a second wave recursively creates the spare state SP. Starting from the root node, the second wave spreads along all edges of the tree adjusting the current state S to the spare state SP. In the pseudocode 800-1, the second wave corresponds to line 10.

It is to be appreciated that the cyclic coloring order guarantees that for each node u in the tree: (i) first, the value (state) of 1 is propagated to node u from the parent node of node u (during the first wave), (ii) next, the value of 1 is propagated to the children of node u (also during the first wave), (iii) then, the value of 1 at node u is used to correct the value of the parent node of node u (if required), however if not, the value of node u might be changed to 0 (during the second wave), and (iv) finally, the value of node u will be made equal to the desired value SP[A] using the children nodes of node u.

Moreover, the pseudocode 800-1 of FIG. 8B shows how to add all other CX-gates so that all edges of the given color c are included in the given CX-layer. Before the first wave (line 7 in the pseudo-code), assuming the value of 1 did not yet reach nodes u and v, so that both S[u] and S[v] are 0, a “dummy” gate CX(u, v) can be added to L (or adding CX(v, u) is equally possible). After the second wave (line 8 in the pseudocode 800-1), under the assumption that SP is sparse, it holds that either S[u]=0 or S[v]=0, hence a dummy CX-gate can be added without changing S. Using the sparsity of the state SP, it can be shown that the process of FIGS. 8A and 8B always produces SP.

In other embodiments, as an additional optimization, the process can be configured to keep track of the dummy gates, and remove CX-layers that consist entirely of dummy gates. The full quantum circuit (which includes the CX-layers to produce SP and layers to produce the target state from the sparse SP) has a depth no greater than M+2K, and at most K unique layers. By way of example, for the edge-colored connectivity graph 600 of FIG. 6, using the process of FIGS. 8A and 8B, a quantum circuit with a depth (total number of CX-layers) of 15 can be obtained.

While FIGS. 8A and 8B were described in the context in which the graph G is an edge-colored tree, a similar process can be implemented in the general case when G is a general graph comprising a collection of vertices (also known as nodes) and edges that connect the vertices. In particular, the process involves selecting a spanning tree T in G, and separating the edges of G into two sets: (i) a first set which includes the “tree” edges in T, and (ii) a second set that includes the “extra” edges in G\T. As is known in the art, a spanning tree T of an undirected graph G is a subgraph that is a tree which includes all of the vertices of G. In addition, the process assigns the colored depth to each tree edge. The pseudocode 800-1 of FIG. 8B is updated as follows.

For each depth d (line 3 of the pseudocode 800-1) consider the set of extra edges of the corresponding color d mod K. First, suppose that for each such extra edge (u, v) it is true that either S[u]=0 or S[v]=0. Then, the tree edges can be handled in the manner as described in lines 7, 8, 9, 10 of the pseudocode 800-1, and add dummy CX gates for extra edges, completing the layer without changing the state S. However, if for some extra edge (u, v), that both S[u]=1 and S[v]=1, then adding either CX(u, v) or CX(v, u) would not be proper.

Instead, a solution is to add two layers L1 and L2 of the corresponding color c, and to modify the code to produce two full layers L1 and L2 instead of a single layer L, which is somewhat similar in nature to the backward state preparation process of FIGS. 5A and 5B. It is to be noted that adding S[u] to S[v] twice does not change S as the addition is done modulo 2. An exemplary process in this regard is shown in FIG. 8C. In particular, FIG. 8C illustrates a block of pseudocode 800-2 which provides a modified process flow (lines 7′-10′) to replace lines 7-10 of the pseudocode 800-1 in FIG. 8B. For all extra edges (u, v), a gate CX(u, v) is added to L1 and L2. At most, the modified process results in adding two layers for each d, leading to at most 2 (M+K)+K CX-layers for the full quantum circuit. However, in practice, only a small number of values of d will require 2 layers. Furthermore, in some cases, it may be possible to construct the sparse state which provably only requires at most 1 layer for each d.

The exemplary methods as discussed above in conjunction with FIGS. 5A, 5B, 6A, 6B, 7, 8A, 8B, and 8C are implemented using connected, edge-colored graphs. In other embodiments, a “forward” algorithm is implemented to generate quantum circuits for preparing a quantum state without relying on an edge-colored graph. In such embodiments, a goal is to construct a state preparation circuit which minimizes both the number of CX-gates and the number of CX-layers. Assuming that every edge of G is part of exactly one unique CX-layer, then the problem can be solved by a process which generally involves (i) edge-coloring the graph G using Vizing's theorem, which states that every simple undirected graph may be edge colored using m or m+1 colors, where m is the maximum degree of a node in G, and (ii) applying the quantum circuit generation process of, e.g., FIGS. 8A, 8B, and 8C.

In some embodiments, if it is not required that every edge of G must be a part of some unique CX-layer, then a more efficient process can be performed as follows. First, remove some edges of G, turning it into a connected tree T, choose one of the nodes to be the root node, and let K be the maximum degree of a node in T (the term degree of a node denotes a number of children of the node, and the degree of T is the maximum degree of a node in the tree).

Then, the process will iteratively compute the depth of the edges of the connected tree T as follows. The edges connecting the root node to its children have depths 0, . . . , p−1 (where p is the degree of the root node). The edges connecting an internal node to its children have depths q+1, . . . , q+p−1 (where p is the degree of this internal node, consequently there is one edge connecting the node to its parent, and p−1 edges connecting it to its children nodes, and q is the depth of the parent edge).

Then, each edge in T can be assigned a color c (edge)=depth (edge) mod K. This forms a valid edge coloring of T. The process of FIGS. 5A and 5B can then be applied on the tree T. In other embodiments, the following heuristics can be applied to reduce the depth of the constructed circuits. When choosing the tree T, first choose a root of G and then apply BFS (breadth-first-search) to find the shortest path connecting each node of G to the root node. When assigning depths to edges of T, the children at each node are ordered based on the depth of the subtree, i.e., exploring child subtrees from the deepest one to the shallowest one.

In other embodiments, as noted above, methods are provided to generate quantum circuits that are configured to prepare quantum states for linear nearest-neighbor connected graphs. A linear nearest-neighbor connected graph is a graph where each vertex is connected to its nearest neighbors, forming a linear structure. Linear nearest-neighbor (LNN) connectivity is especially important due to its simplicity and omnipresence (wherein many different architectures contain long lines of connected qubits). While a line over n qubits is a special case of a tree, certain constructions can be somewhat improved when assuming LNN connectivity.

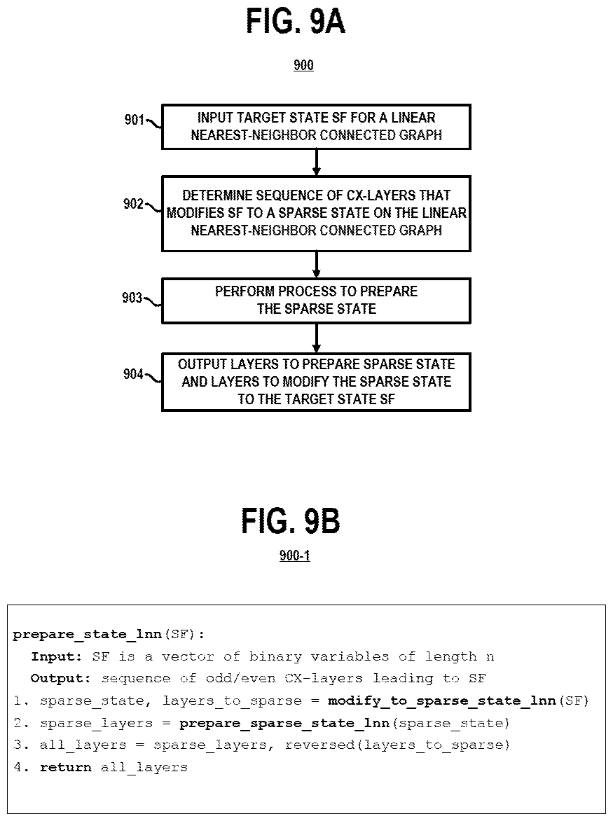

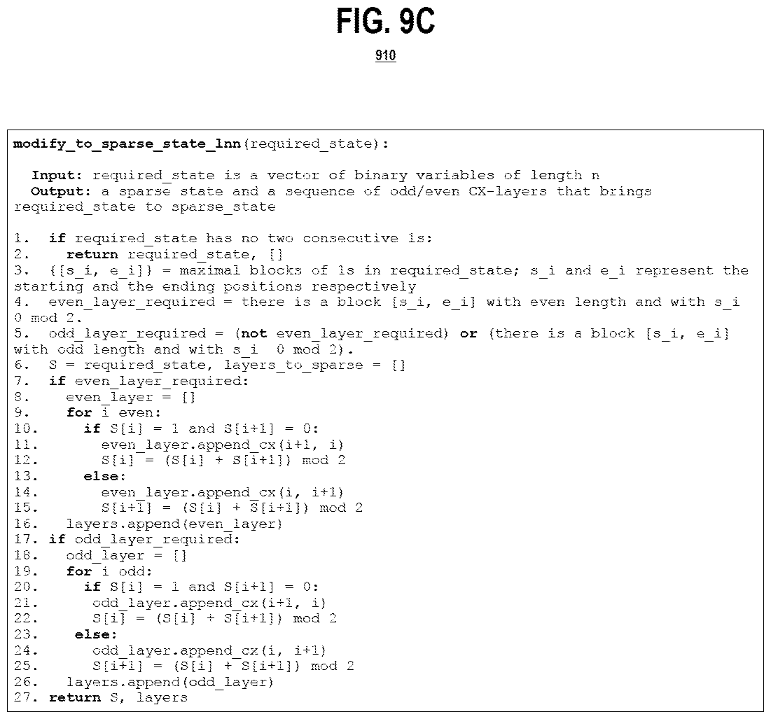

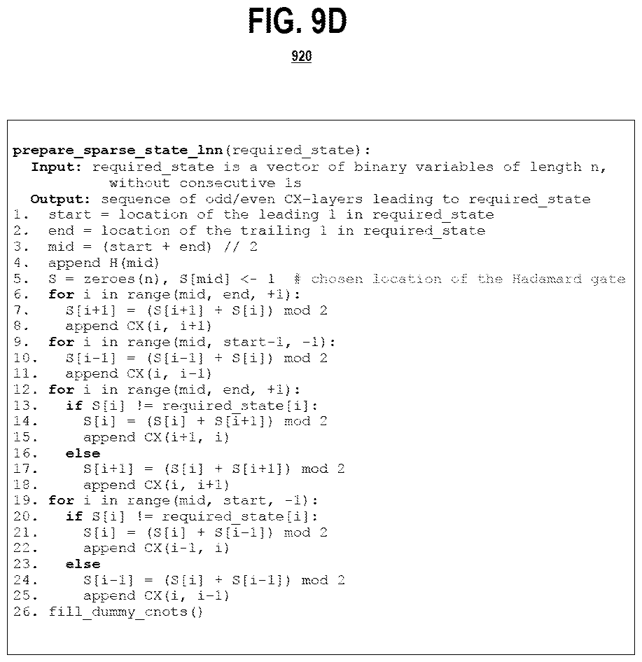

In particular, a line over n qubits can be edge-colored with two colors. A first color is assigned to all even edges, connecting qubit_i and qubit_i+1, where i includes even integers. A second color is assigned to all odd edges, connecting qubit_j and qubit j+1, where j includes odd integers. A state on a LNN architecture is deemed sparse if the state has no two consecutive 1s. In some embodiments, a general state preparation process for an LNN connected graph is configured to reduce a target state to a sparse state. For example, FIGS. 9A, 9B, 9C, and 9D collectively illustrate a process for generating a quantum circuit that is configured to prepare a quantum state of a multi-qubit register on an LNN connected graph, according to another exemplary embodiment of the disclosure. In particular, FIG. 9A illustrates a flow diagram of a method 900 for generating a quantum circuit that is configured to prepare a quantum state of a multi-qubit register on an LNN connected graph, and FIG. 9B illustrates a block of pseudocode 900-1 which provides additional details of the exemplary quantum circuit generation process of FIG. 9A, according to an exemplary embodiment of the disclosure. In addition, FIGS. 9C and 9D illustrate respective blocks of pseudocode 910 and 920 which describe details of the exemplary quantum circuit generation process of FIGS. 9A and 9B.

Referring to FIG. 9A, the exemplary method 900 includes an initial step of receiving as input a target state SF for an LNN connected graph (block 901). The target state SF represents a desired state of an n-qubit register to be prepared, wherein the target state SF comprises a sequence of 0s and 1s, and length n. Next, the process proceeds to determine a sequence of CX-layers that is configured to modify the target state SF to a sparse state on the LNN connected graph (block 902). In particular, this process involves determining a sequence of even/odd CX-layers that modifies SF to a sparse state. The process of block 902 corresponds to line 1 of the block of pseudocode 900-1, wherein the process determines sequence of even/odd CX-layers (denoted, layers_to_sparse) that modifies SF to a sparse state (denoted, sparse_state) using an exemplary procedure denoted modify_to_sparse_state_Inn. The pseudocode 910 of FIG. 9C describes an exemplary process for implementing the procedure modify_to_sparse_state_Inn, according to an exemplary embodiment of the disclosure.

Next, the process proceeds to prepare the sparse state (block 903). The process of block 903 corresponds to line 2 of the block of pseudocode 900-1 of FIG. 9B, wherein the sparse state is prepared using an exemplary procedure denoted prepare_sparse_state_Inn. The pseudocode 920 of FIG. 9D describes an exemplary process for implementing the procedure prepare_sparse_state_Inn, according to an exemplary embodiment of the disclosure.

The process outputs a plurality of layers including layers that are configured to prepare the sparse state, along with layers that are configured to modify the sparse state to the target state SF (block 904). In particular, the process of block 904 corresponds to lines 3 and 4 of the block of pseudocode 900-1, wherein the process outputs all_layers which include the sparse_layers for preparing the sparse state, and the layers_to_sparse, in reversed order, for modifying the sparse state to the target state SF.

As noted above, the pseudocode 910 of FIG. 9C describes an exemplary process for implementing the procedure modify_to_sparse_state_Inn. In some embodiments, the procedure modify_to_sparse_state_Inn is a specialized version of the algorithm for general graphs, as presented above, which uses a smallest number of layers (either 0, 1, or 2) to reduce a state to a sparse state using at most 1 even layer and at most one odd layer. If a required_state is already sparse (that is, does not contain consecutive 1s), then there is nothing to be done. Otherwise, the procedure collects starting and ending positions of maximal blocks of 1s in the required_state.

For example, assuming a required_state=11100011110010, then the starting and ending positions of the maximal blocks of 1s are {[0, 2], [6, 9], [12, 12]}. If there is a block of consecutive 1s with an even number of 1s and starting at an even position, then an even layer is required. Similarly, if there is a block of consecutive 1s with an even layer of 1s and starting at an odd position, then an odd layer is required. If neither an even layer nor an odd layer is required, the process arbitrarily chooses that an odd layer is required (since at least one CX-layer is needed). The lines 7-26 of the pseudocode 910 describe a process to construct even and/or odd layers, respectively. The procedure shown in FIG. 9C will always produce a sparse state, and creates at most 2 CX-layers, and can be implemented to run in linear time.

Moreover, as noted above, the pseudocode 920 of FIG. 9D describes an exemplary process for implementing the procedure prepare_sparse_state_Inn, which works as follows. The procedure (lines 1-5 of pseudocode 920) finds the positions of the leading 1 (start) and the trailing 1 (end) in the sparse state, and finds the middle between the two, which is the location of the Hadamard gate. Next, a first “for loop” (lines 6-8 of pseudocode 920) and a second “for loop” (lines 9-11 of pseudocode 920) describe a process to construct a “wave” of CX-gates that propagate a value of 1 downwards and upwards towards the end and start positions, respectively. The process also keeps track of the current state S. After these two steps, S contains 1 between start and end, inclusive. After this, the algorithm constructs a second “wave” of CX-gates that brings S to the required_state. The last step of the algorithm (line 26) adds dummy CX-gates to complete the construction of odd/even layers.

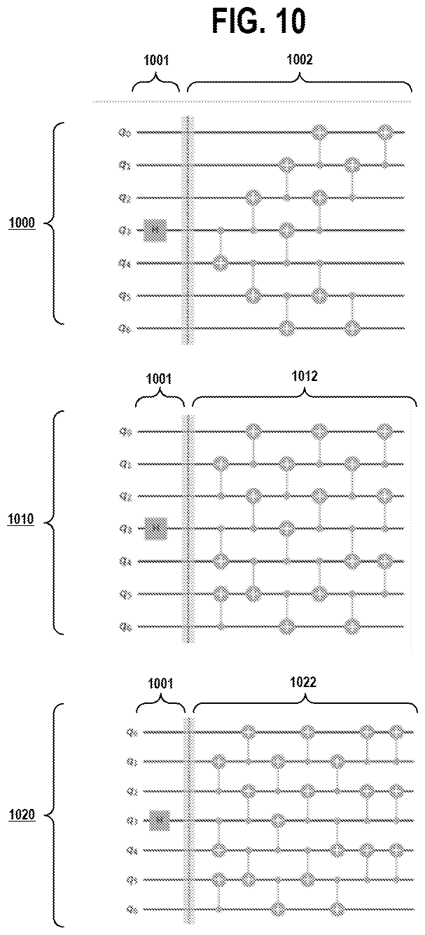

By way of example, assume a target state comprises a GHZ state over 7 qubits, i.e., 1111111. Using an even layer of CX-gates, the GHZ state can be modified to a sparse state 1010101 (which happens to be a checkerboard state). FIG. 10 schematically illustrates exemplary quantum circuits that are generated as a result of performing the procedure prepare_sparse_state_Inn to prepare the sparse state 1010101 of the GHZ state over a 7-qubit register comprising qubits q₀, q₁, q₂, q₃, q₄, q₅, and q₆. The procedure prepare_sparse_state_Inn returns a quantum circuit 1000, which comprises an initial layer 1001 having a Hadamard gate H applied to qubit q₃, and a plurality of CX-layers 1002 having six (6) CX-layers (depth of 6). Adding dummy CX-gates to some of the CX-layers 1002 produces a quantum circuit 1010 having a plurality of CX-layers 1012 of depth 6. Finally, adding an even layer at the end of the quantum circuit 1012 produces a quantum circuit 1020 with seven (7) CX-layers 1022 (depth of 7).

By a depth analysis, it can be shown that creating a sparse state requires a depth of k+2 for even n (n=2k) and depth of k+3 for odd n (n=2k+1). Since constructing an arbitrary state requires at most two more layers, the full algorithm prepare_state_Inn requires depth of n/2 +4=k+4 for even n (n=2k) and a depth of (n+1)/2+4=k+5 for odd n (n=2k+1).

In some embodiments, the prepare_state_Inn process (e.g., FIGS. 9A and 9B) can be readily adapted for constructing GHZ and checkerboard states. In particular, a direct adaptation of the prepare_state_Inn process for special states, such as GHZ and checkerboard states, is obtained from the general construction by virtue of the fact that (i) only a single even CX-layer is needed to reduce a GHZ state to a sparse state, and that (ii) no CX-layers are needed to reduce a checkerboard state to a sparse state, as the checkerboard state is already sparse state.

Moreover, in other embodiments, a specialized algorithm is provided for generating GHZ states for odd values of n=2k+1, for an LNN architecture. The GHZ state generation process can be thought of as a sequence of states, where each state is obtained from the previous by an odd or even layer of CX gates. For example, in some embodiments, optimal constructions for k≤4 (i.e., 1≤k≤4) can be implemented using BFS, as follows:
(1) for k=1:010→011→111
(2) for k=2:00100→00110→00111→01101→11111
(3) for k=3:0001000→0001100→0011110→0010010→0110011→1111111
(4) for k=4:000010000→000011000→000111100→000110110→001110010→011010011 →111111111.

For constructions with k≥5, a process can differentiate between the case where k is even, and the case where k is odd. In both cases, a goal is to reach a state of the form 01(10)^{a}(01)^{b}1. In particular, when k=2t is even, a=t−1, and b=t, while when k=2t+1 is odd, then a=b=t. In each case, a single CX-layer is sufficient to convert all the 01 and 10 pairs to 11, reaching the desired GHZ state. It remains to explain how 01(10)^{a}(01)^{b}1 can be reached in k steps.

A key observation is the following two-step transition: 001(10)^{a}(01)^{b}100→01(11)^{a}0(01)^{b}110→1(10)^{a+1}(01)^{b+1}1. This demonstrates how a desired state can be inductively expanded until it encompasses the entire state. To elaborate on the way this transition is performed, assume an initial state 001(10)^{a}(01)^{b}100—this might have extra “0” values to the left and right which play no part in the following. Then, an odd layer can be chosen while leaving the leftmost “0” alone, which begins by transforming 01 to 10. Finally, the first a−1 values are transformed from 10 to 11, keeping the last 10 intact. The b values of 01 are also kept intact, and the last 10 is transformed to 11. This results in the state 01(11)^{a}0(01)^{b}110.

In a next step, an even layer is utilized. For example, assume that an intermediate state, when the elements are paired accordingly, is: 01(11)^{a}0(01)^{b}110=01(11)^{a}00(10)^{b-1}1110. Next, the process (i) transforms the initial 01 to 11, (ii) transforms all the “a” pairs of 11 to 01, keeping the 00 as it is, keeping the next b−1 pairs of 10 as they are, transforming the next 11 to 10, and (iii) transforms the last 10 to 11, thereby reaching the following state: 11(01)^{a}00(10)^{b-1}(10)11=1(10)^{a+1}(01)^{b+1}1.

In particular, the full algorithm is as follows. Assuming k=2t, begin by the transition: 0000001000000→0000001100000→0000011110000→0000111011000→0001110111100→0011100101110→0110100101011. This exemplary 6-step transition leads to the state 01(10)²(01)³1 from which the inductive part of the algorithm can commence. Since the goal is to reach 01(10)^{t-1}(01)^{t}1, the inductive part needs to be repeated t−3 times, each one using two steps. Hence the total number of steps is 6+2 (t−3)=2t=k steps, with one more to reach the desired GHZ state.

Further, assuming that k=2t+1, an exemplary transition is as follows: 00000100000 →00000110000→00001111000→00011101100→00111001110→01101001011. This exemplary 5-step transition leads to 01(10)²(01)²1. An inductive process is then performed t−2 times, requiring a total of 5+2 (t−2)=2t+1=k steps.

Various techniques can be implemented to optimize the state preparation techniques as discussed herein. For example, when k=2, 3, or 4, an optimal depth is k+2. For all the other values of k, an optimal depth is k+1. The k+1 lower bound can be easily proved by considering the number of steps required to propagate a single “1” value to both ends of the state. Here, it does not matter where the initial “1” is placed, since after one step, there will still be a sequence of k consecutive “0” values, and each step can turn only one such “0” to “1”. This lower bound applies to any state where both ends of the state are “1”.

Moreover, optimizations can be implemented for, e.g., the exemplary 65-qubit lattice architecture, as shown in FIG. 2. For example, a line can be drawn through 57 out of the 65 qubits of the qubit lattice. In this regard, if a superposed state needs to be prepared on n≤57 qubits of the qubit lattice, the exemplary LNN process of FIGS. 9A-9D can be utilized. The constructed circuit has a depth ˜n/2, but only 2 unique layers. In contrast, the exemplary general algorithm as discussed above, allows preparation of states with a smaller depth at the cost of 1 additional layer. The same considerations also apply to other connectivity graphs.

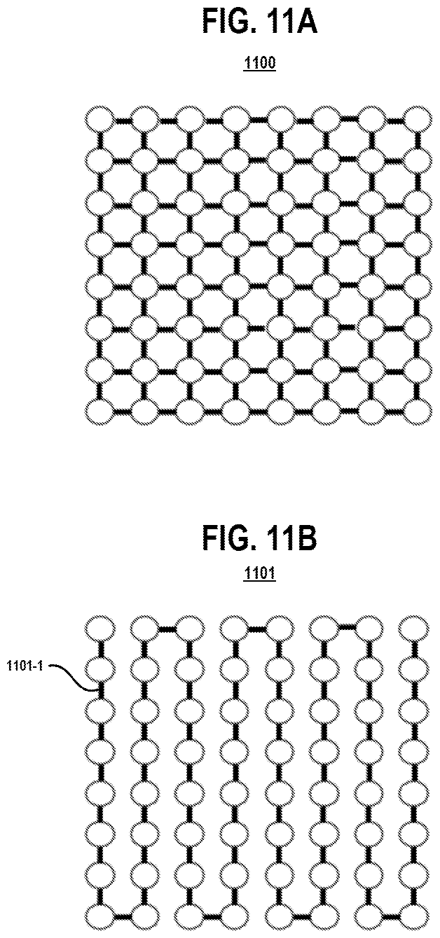

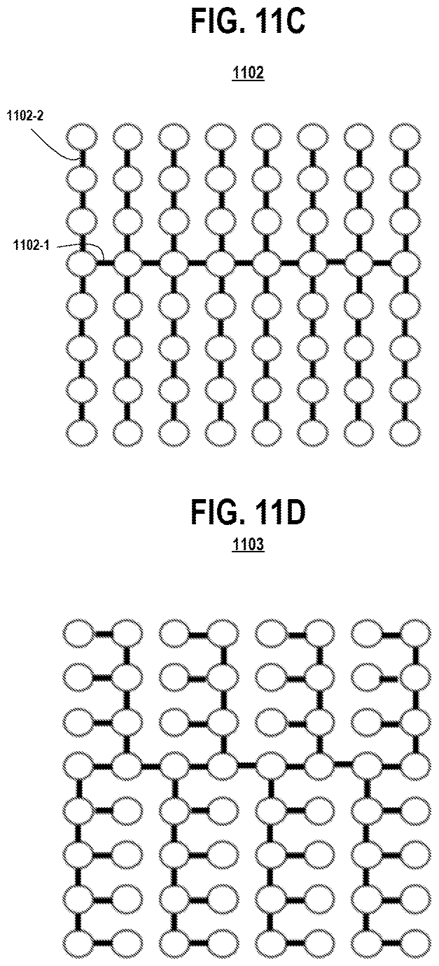

In other embodiments, state preparation techniques can be implemented for grid architectures. For example, FIG. 11A schematically illustrates an exemplary grid architecture 1100 comprising a grid of n×n nodes (qubits), where n2 qubits are organized in a grid. In the exemplary embodiment of FIG. 11, the grid architecture 1100 comprises an 8×8 grid architecture comprising 64 qubits, wherein each qubit is connected to a qubit to the left, the right, above, and/or below the qubit.

FIG. 11B schematically illustrates an exemplary embodiment of a grid architecture 1101 to which exemplary state preparation techniques as discussed herein can applied. The grid architecture 1101 comprises n ×n nodes (e.g., n=8) with a line 1101-1 that passes through every qubit of the grid architecture 1101 providing LNN connectivity. In this regard, any of the exemplary GHZ/general state preparation algorithms for LNN connectivity can be utilized to prepare a quantum state. As noted above, the state preparation algorithms for LNN connectivity can be implemented with two (2) unique CX-layers, and such algorithms have depth ˜n²/2.

Next, FIG. 11C illustrates an exemplary embodiment of a grid architecture 1102 to which exemplary state preparation techniques as discussed herein can applied. The grid architecture comprises n x n nodes (e.g., n=8) and comprises a horizontal line 1102-1 which passed through a central qubit, and vertical lines 1102-2 which pass through respective vertical columns of connected qubits. Starting from the center qubit, a GHZ state can be prepared along the horizontal line 1102-1 which passes through the center qubit (using the GHZ algorithm for linear nearest-neighbor connectivity). Then, in parallel, GHZ states can be prepared along the respective vertical lines 1102-2. Overall, a GHZ state can be prepared with 4 unique layers and with a depth ˜n. Moreover, the general algorithm can be also used for the shown tree, allowing to prepare any superposed state in depth ˜n and with 4 unique layers, wherein 4 unique layers are needed because the center qubit has degree 4.

Next, FIG. 11D illustrates an exemplary embodiment of a grid architecture 1103 to which exemplary state preparation techniques as discussed herein can be applied. The grid architecture 1103 comprises a modified version of the tree structure shown in FIG. 11C, wherein the tree is modified to a degree-3 graph while guaranteeing that every edge has depth at most ˜n. Thus, the exemplary general algorithm as discussed above allows any superposed state to be prepared with depth ˜n and with 3 unique layers.

It is known that the family of quantum states of the form

$$\frac{1}{\sqrt{2}} \vert α 〉 + \frac{1}{\sqrt{2}} \vert β 〉 ,$$

which comprise important states like GHZ states, can be generated in log-depth on a fully connected architecture. However, such circuits are not practical because all-to-all architectures are not scalable. The exemplary algorithms as described herein show that even when the circuit structure is constrained to minimize the unique CX-layers and the qubit lattice of the quantum device is only assumed to have linear architecture, the state preparation for such family of quantum states can be performed using linear-depth circuits.

In general, the exemplary algorithms as described herein can be applied to various quantum computing tasks where gate-efficient state preparation needs to be combined with advanced mitigation methods like PEC and ZNE. For example, the methods can be used to generate GHZ states, and to estimate the ground state of quantum many-body systems. The exemplary methods can generate superposed states, such as the checkerboard and GHZ states, which are useful initial states in circuits for estimating ground state energies for many-body systems. The exemplary techniques as discussed herein can be integrated as part of the Qiskit synthesis library. As is known in the art, Qiskit is an open-source software development kit (SDK) for programming and working with quantum computers at the level of pulses, circuits, and application modules.

The exemplary techniques discussed herein for synthesizing superposed state circuits and reducing the number of the unique gate layers, are advantageously useful for efficiently learning and effectively mitigating quantum noise using advanced mitigation methods such as PEC and ZNE. In addition, the exemplary techniques described herein provide systems and methods for high density synthesis of a quantum state preparation circuit of superposed states, wherein quantum synthesis algorithms enable the construction of quantum circuits with a small depth and a minimal number of unique gate layers.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

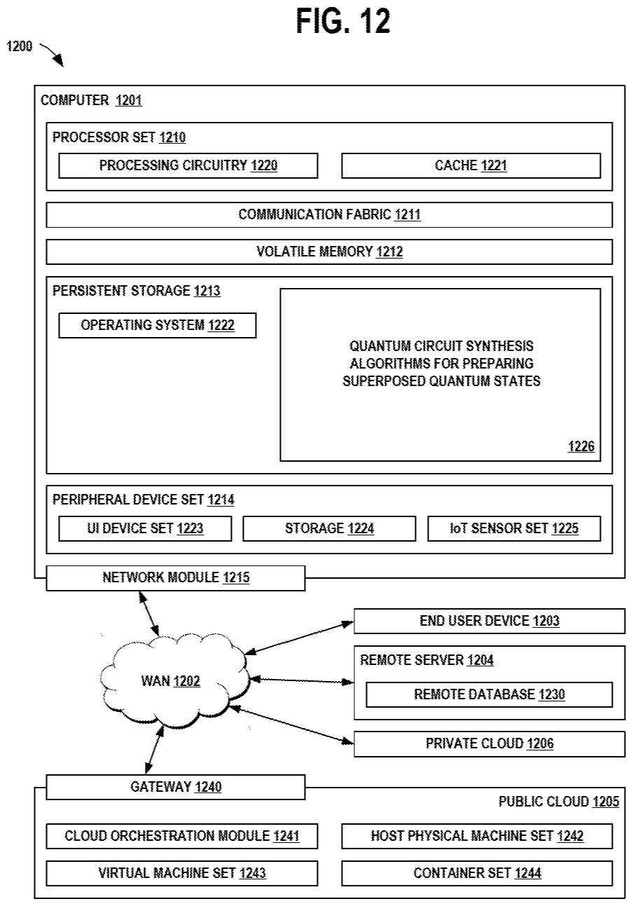

Computing environment 1200 of FIG. 12 contains an example of an environment for the execution of at least some of the computer code (block 1226) involved in executing quantum circuit synthesis algorithms for preparing superposed quantum stats, as discussed herein. In addition to block 1226, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1226, as identified above), peripheral device set 1214 (including user interface (UI), device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

Computer 1201 may take the form of a desktop computer, laptop computer, tablet computer, smart phone, smart watch or other wearable computer, mainframe computer, or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be located in a cloud, even though it is not shown in a cloud in FIG. 12. On the other hand, computer 1201 is not required to be in a cloud except to any extent as may be affirmatively indicated.

Processor set 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1226 in persistent storage 1213.

Communication fabric 1211 is the signal conduction path that allow the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1212 is any type of volatile memory now known or to be developed in the future. Examples include dynamic type random access memory (RAM) or static type RAM. Typically, the volatile memory is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

Persistent storage 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open source Portable Operating System Interface type operating systems that employ a kernel. The code included in block 1226 typically includes at least some of the computer code involved in performing the inventive methods.

Peripheral device set 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer and another sensor may be a motion detector.

Network module 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

Remote server 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

Public cloud 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

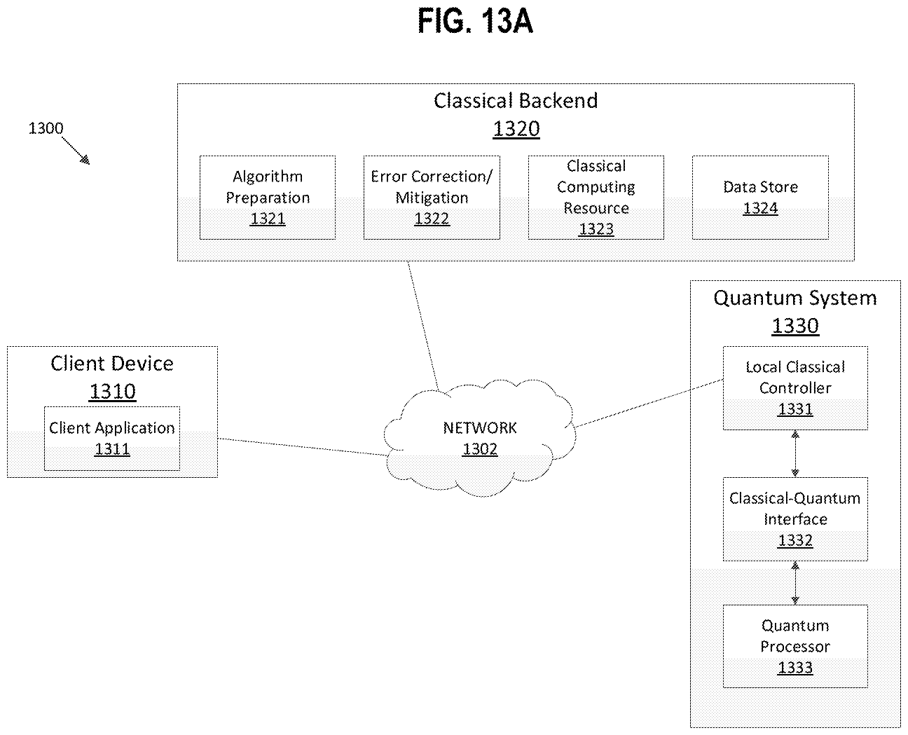

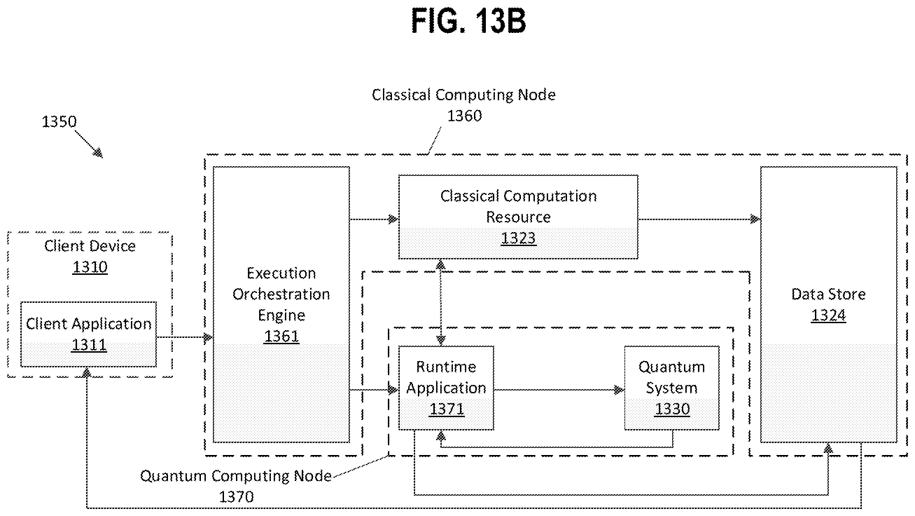

FIG. 13A illustrates a block diagram of an example hybrid computing system 1300 that can facilitate execution of a quantum algorithm. As shown, a client device 1310 may interface with a classical backend 1320 to enable computations with the aid of a quantum system 1330.

Network 1302 may be any combination of connections and protocols that will support communications between the client device 1310, the classical backend 1320, and the quantum system 1330. In an example embodiment, network 1302 may be the WAN 1202.

Client device 1310 may be an implementation of computer 1201 or EUD 1203, as described in FIG. 12, and configured to operate in a hybrid computing system 1300.

Client application 1311 may include an application or program code that includes computations requiring a quantum algorithm or quantum operation. In an embodiment, client application 1311 may include an object-oriented programming language, such as Python® (“Python” is a registered trademark of the Python Software Foundation), capable of using programming libraries or modules containing quantum computing commands or algorithms, such as QISKIT (“QISKIT” is a registered trademark of the International Business Machines Corporation). In another embodiment, client application 1311 may include machine level instructions for performing a quantum circuit, such as OpenQASM. Additionally, user application may be any other high-level interface, such as a graphical user interface, having the underlying object oriented and/or machine level code as described above.

In some embodiments, the classical backend 1320 is an implementation of the computer 1201 of FIG. 12, as described above, having program modules configured to operate in a hybrid computing system 1300. Such program modules for classical backend 1320 may include algorithm preparation 1321, classical computing resource 1323, and data store 1324.

Algorithm preparation 1321 may be a program or module capable of preparing algorithms contained in client application 1311 for operation on quantum system 1330. Algorithm preparation 1321 may be instantiated as part of a larger algorithm, such as a function call of an API, or by parsing a hybrid classical-quantum computation into aspects for quantum and classical calculation. Algorithm preparation 1321 may additionally compile or transpile quantum circuits that were contained in client application 1311 into an assembly language code for use by the local classical controller 1331 to enable the quantum processor 1333 to perform the logical operations of the circuit on physical structures. During transpilation/compilation an executable quantum circuit in the quantum assembly language may be created based on the calculations to be performed, the data to be analyzed, and the available quantum hardware. In one example embodiment, algorithm preparation 1321 may select a quantum circuit from a library of circuits that have been designed for use in a particular problem. In another example embodiment, algorithm preparation 1321 may receive a quantum circuit from the client application 1311 and may perform transformations on the quantum circuit to make the circuit more efficient, or to fit the quantum circuit to available architecture of the quantum processor 1333. Additionally, algorithm preparation 1321 may prepare classical data from data store 1324, or client application 1311, as part of the assembly language code for implementing the quantum circuit by the local classical controller 1331. Algorithm preparation 1321 may additionally set the number of shots (i.e., one complete execution of a quantum circuit) for each circuit to achieve a robust result of the operation of the algorithm. Further, algorithm preparation 1321 may update, or re-compile/re-transpile, the assembly language code based on parallel operations occurring in classical computing resource 1323 or results received during execution of the quantum calculation on quantum system 1330. Additionally, algorithm preparation 1321 may determine the criterion for convergence of the quantum algorithm or hybrid algorithm.

Error correction/mitigation 1322 may be a program or module capable of performing error correction or mitigation techniques for improving the reliability of results of quantum computations. Error correction is the most basic level of error handling. Error suppression refers to techniques where knowledge about the undesirable effects of quantum hardware is used to introduce customization that can anticipate and avoid the potential impacts of those effects, such as modifying signals from Classical-quantum interface 1332 based on the undesirable effects. Error mitigation uses the outputs of ensembles of circuits to reduce or eliminate the effect of noise in estimating expectation values. Error mitigation may include techniques such as Zero Noise Extrapolation (ZNE) and Probabilistic Error Correction (PEC).

Classical computing resource 1323 may be a program or module capable of performing classical (e.g., binary, digital) calculations contained in client application 1311. Classical calculations may include formal logical decisions, AI/ML algorithms, floating point operations, and/or simulation of Quantum operations.

Data store 1324 may be a repository for data to be analyzed using a quantum computing algorithm, as well as the results of such analysis. Data store 1324 may be an implementation of storage 1224 and/or remote database 1230 (FIG. 12), configured to operate in a hybrid computing system 1300.

The quantum system 1330 can be any suitable set of components capable of performing quantum operations on a physical system. In the example embodiment depicted in FIG. 13A, quantum system 1330 includes a local classical controller 1331, a classical-quantum interface 1332, and quantum processor 1333. In some embodiments, all, or part of each of the local classical controller 1331, a classical-quantum interface 1332, and quantum processor 1333 may be located in a cryogenic environment to aid in the performance of the quantum operations. In some embodiments, the classical backend 1320 and the quantum system 1330 may be co-located to reduce the communication latency between the devices.

Local classical controller 1331 may be any combination of classical computing components capable of aiding a quantum computation, such as executing one or more quantum operations to form a quantum circuit, by providing commands to a classical-quantum interface 1332 as to the type and order of signals to provide to the quantum processor 1333. Local classical controller 1331 may additionally perform other low/no latency functions, such as error correction, to enable efficient quantum computations. Such digital computing devices may include processors and memory for storing and executing quantum commands using classical-quantum interface 1332. Additionally, such digital computing devices may include devices having communication protocols for receiving such commands and sending results of the performed quantum computations to classical backend 1320. Additionally, the digital computing devices may include communications interfaces with the classical-quantum interface 1332. In an embodiment, local classical controller 1331 may include all components of the computer 1201 (FIG. 12), or alternatively may be individual components configured for specific quantum computing functionality, such as processor set 1210, communication fabric 1211, volatile memory 1212, persistent storage 1213, and network module 1215 (FIG. 12).

Classical-quantum interface 1332 may be any combination of devices capable of receiving command signals from local classical controller 1331 and converting those signals into a format for performing quantum operations on the quantum processor 1333. Such signals may include electrical (e.g., RF, microwave, DC) or optical signals to perform one or more single qubit operations (e.g., Pauli gate, Hadamard gate, Phase gate, Identity gate), signals to preform multi-qubit operations (e.g., CNOT-gate, CZ-gate, SWAP gate, Toffoli gate), qubit state readout signals, and any other signals that might enable quantum calculations, quantum error correction, and initiate the readout of a state of a qubit. Additionally, classical-quantum interface 1332 may be capable of converting signals received from the quantum processor 1333 into digital signals capable of processing and transmitting by local classical controller 1331 and classical backend 1320. Such signals may include qubit state readouts. Devices included in classical-quantum interface 1332 may include, but are not limited to, digital-to-analog converters, analog-to-digital converters, waveform generators, attenuators, amplifiers, filters, optical fibers, and lasers.

Quantum processor 1333 may be any hardware capable of using quantum states to process information. Such hardware may include a collection of qubits, mechanisms to couple/entangle the qubits, and any required signal routings to communicate between qubits or with classical-quantum interface 1332 in order to process information using the quantum states. Such qubits may include, but are not limited to, charge qubits, flux qubits, phase qubits, spin qubits, and trapped ion qubits. The architecture of quantum processor 1333, such as the arrangement of data qubits, error correcting qubits, and the couplings amongst them, may be a consideration in performing a quantum circuit on quantum processor 1333.

In some embodiments, the algorithm preparation 1321 comprises a program or module that is configured to implement the exemplary quantum circuit synthesis methods as discussed herein for synthesizing quantum state initialization circuits for preparing superposed states of quantum bit registers, which can be utilized in conjunction with many types of quantum computing algorithms (e.g., ground state energy estimation algorithms) which utilize initialized superposed quantum states of quantum bit registers to perform associated quantum computations. For example, in some embodiments, the algorithm preparation 1321 comprises a program or module that is configured to implement a method for generating a quantum circuit for preparing an initial target superposed state of a quantum bit register on an array of quantum bits represented by a connectivity graph which comprises edges and vertexes in which each edge is assigned one label of a given set of unique labels such that no vertex of the connectivity graph is incident to two edges assigned with a same label. In generating the quantum circuit, the algorithm preparation 1321 program/module is configured to (i) generate an initial layer of the quantum circuit, wherein the initial layer comprises a single-qubit gate that is configured to place the quantum bit register in an initial superposed state, and (ii) generate a sequence of layers of the quantum circuit following the initial layer, which are configured to generate the target superposed state of the quantum bit register, wherein the sequence of layers comprises a plurality of layers of a same type of controlled two-qubit gate that is configured to conditionally flip a state of a target quantum bit based on a state of a control quantum bit, wherein a number of unique layers of the plurality of layers of the same type of controlled two-qubit gate in the sequence of layers is no greater than a number of unique labels in the given set of labels for the connectivity graph. The local classical controller 1331 of the quantum system 1330 is configured to process and execute such quantum state initialization circuits to prepare initial superposed states of quantum bit registers in an array of quantum bits of the quantum processor 1333, and to process and execute associated quantum computing algorithms (e.g., ground state energy estimation algorithms) which utilize the initialized superposed quantum states of the quantum bit registers to perform associated quantum computations.

Advantageously, the exemplary quantum state initialization circuits for preparing superposed states of quantum bit registers provide significant improvements to computer functionality as well as technical improvements to existing technological processes for generating superposed states of quantum bit registers. For example, the exemplary quantum circuit synthesis techniques are generated configured to generate quantum state initialization circuits that are both depth-efficient and use the minimal number of unique layers. This has a multiplicative effect in enhancing both computer performance and the efficiency and accuracy of quantum computing algorithms. The exemplary quantum state initialization circuits allow for a reduction in the decoherence experienced during quantum circuit execution, allow for error mitigation to increase algorithmic performance, and allow for a reduction in the total runtime by minimizing the number of layers and required experiments.

For example, advanced error mitigation methods, such as Probabilistic Error Cancellation and Zero Noise Extrapolation, need to learn a noise model associated with, e.g., the unique controlled-NOT (CX) layers of a state initialization quantum circuit. In this regard, the exemplary techniques as described herein for synthesizing quantum state initialization circuits are configured to minimize the number of unique CX-layers, thus enhancing the functionalities of advanced error mitigation methods, such as Probabilistic Error Cancellation and Zero Noise Extrapolation. Indeed, a larger number of CX-layers not only increases the computer runtime, but also increases a risk of failure because noise of the quantum device (e.g., quantum processor) might drift away from the learned noise model. The exemplary quantum state initialization circuit synthesis techniques as described herein are configured to fix and minimize the number of CX-layers of a state initialization quantum circuit based on the number of unique colors of a corresponding edge-colored connectivity graph.

Referring now to FIG. 13B, a block diagram is depicted showing an example architecture, and data transmission, of a hybrid computation system 1350 employed using a cloud architecture for classical backend 1320. Hybrid computation system 1350 receives an algorithm containing a computation from a client application 1311 of client device 1310. Upon receipt of the algorithm and request from client application 1311, hybrid computation system 1350 instantiates a classical computing node 1360 and a quantum computing node 1370 to manage the parallel computations. The classical computing node 1360 may include one or more classical computers capable of working in tandem (e.g., utilizing the cloud computing environment described with reference to FIG. 12). For example, classical computing node 1360 may include an execution orchestration engine 1361, one or more classical computation resources 1323, and a result data store 1324. The quantum system 1330 may include a combination of classical and quantum computing components acting together to perform quantum calculations on quantum hardware including, for example, one or more quantum systems 1330. The quantum computing node 1370 may include a quantum runtime application 1371 and one or more quantum systems 1330.

The client application 1311 may include programing instructions to perform quantum and classical calculations. In an embodiment, client application 1311 may be in a general-purpose computing language, such as an object-oriented computing language (e.g., Python®), that may include classical and quantum functions and function calls. This may enable developers to operate in environments they are comfortable with, thereby enabling a lower barrier of adoption for quantum computation.

The execution orchestration engine 1361, in using algorithm preparation 1321, may parse the client application 1311 into a quantum logic/operations portion for implementation on a quantum computing node 1370, and a classical logic/operations portion for implementation on a classical computing node 1360 using a classical computation resource 1323. In an embodiment, parsing the client application 1311 may include performing one or more data processing steps prior to operating the quantum logic using the processed data. In an embodiment, parsing the client application 1311 may including segmenting a quantum circuit into portions that are capable of being processed by quantum computing node 1370, in which the partial results of each of the segmented quantum circuits may be recombined as a result to the quantum circuit. Execution orchestration engine 1361 may parse the hybrid algorithm such that a portion of the algorithm is performed using classical computation resources 1323 and a session of quantum computing node 1370 may open to perform a portion of the algorithm. The quantum runtime application 1371 may communicate, directly or indirectly, with classical computation resources 1323 by sending parameters/information between the session to perform parallel calculations and generate/update instructions of quantum assembly language to operate quantum system 1330, and receiving parameters/information/results from the session on the quantum system 1330. Following the parsing of the hybrid algorithm for calculation on quantum computing node 1370 and classical computing node 1360, the parallel nodes may iterate the session to convergence by passing the results of quantum circuits, or partial quantum circuits, performed on quantum system 1330 to classical computing resource 1323 for further calculations. Additionally, runtime application 1371, using algorithm preparation 1321, may re-parse aspects of the hybrid algorithm to improve convergence or accuracy of the result. Such operation results, and progress of convergence, may be sent back to client device 1310 as the operations are being performed. By operating execution orchestration engine 1361 in a cloud environment, the environment may scale (e.g., use additional computers to perform operations necessary) as required by the client application 1311 without any input from the creators/implementors of client application 1311. Additionally, execution orchestration engine 1361, while parsing the client application 1311 into classical and quantum operations, may generate parameters, function calls, or other mechanisms in which classical computation resource 1323 and quantum computing node 1370 may pass information (e.g., data, commands) between the components such that the performance of the computations enabled by client application 1311 is efficient.

Classical computation resources 1323 may perform classical computations (e.g., formal logical decisions, AI/ML algorithms, floating point operations, simulation of Quantum operations) that aid/enable/parallelize the computations instructed by client application 1311. By utilizing classical computation resources 1323 in an adaptively scalable environment, such as a cloud environment, the environment may scale (e.g., use additional computers to perform operations necessary including adding more classical computing resources 1323, additional quantum systems 1330, and/or additional resources of quantum systems 1330 within a given quantum computing node 1370) as required by the client application 1311 without any input from the creators/implementors/developers of client application 1311, and may appear seamless to any individual implementing client application 1311 as there are no required programming instructions in client application 1311 needed to adapt to the classical computation resources 1323. Thus, for example, such scaling of quantum computing resources and classical computing resources may be provided as needed without user intervention. Scaling may reduce the idle time, and thus reduce capacity and management of computers in classical computing node 1360.

The result data store 1324 may store, and return to client device 1310, states, configuration data, etc., as well as the results of the computations of the client application 1311.

Implementation of the systems described herein may enable hybrid computing system 1300, through the use of quantum system 1330, to process information, or solve problems, in a manner not previously capable. The efficient parsing of the quantum or hybrid algorithm into classical and quantum segments for calculation may achieve efficient and accurate quantum calculations from the quantum system 1330 for problems that are exponentially difficult to perform using classical backend 1320. Additionally, the quantum assembly language created by classical backend 1320 may enable quantum system 1330 to use quantum states to perform calculations that are not classically efficient or accurate. Specifically, as noted above, the exemplary quantum circuit synthesis techniques for preparing superposed states can be applied to various quantum computing tasks where gate-efficient state preparation needs to be combined with advanced mitigation methods like PEC and ZNE. For example, the methods can be used to generate GHZ states, and to estimate the ground state of quantum many-body systems. The exemplary methods can generate superposed states, such as the checkerboard and GHZ states, which are useful initial states in circuits for estimating ground state energies for many-body systems. In addition, the exemplary techniques discussed herein for synthesizing superposed state circuits and reducing the number of the unique gate layers, are advantageously useful for efficiently learning and effectively mitigating quantum noise using advanced mitigation methods such as PEC and ZNE. In addition, the exemplary techniques described herein provide systems and methods for high density synthesis of a quantum state preparation circuit of superposed states, wherein quantum synthesis algorithms enable the construction of quantum circuits with a small depth and a minimal number of unique gate layers. Such technical improvements may reduce the classical resources required to perform the calculation of the quantum or hybrid algorithm, by improving the capabilities of the quantum system 1330.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
memory that is configured to store program instructions; and
processing circuitry, coupled to the memory, and configured to execute the program instructions to perform a process to generate a quantum circuit for preparing a target superposed state of a quantum bit register on a connectivity graph which comprises edges and vertexes in which each edge is assigned one label of a given set of unique labels such that no vertex of the connectivity graph is incident to two edges assigned with a same label, wherein in performing the process, the processing circuitry is configured to:
generate an initial layer of the quantum circuit, wherein the initial layer comprises a single-qubit gate that is configured to place the quantum bit register in an initial superposed state; and
generate a sequence of layers of the quantum circuit following the initial layer, which are configured to generate the target superposed state of the quantum bit register, wherein the sequence of layers comprises a plurality of layers of a same type of controlled two-qubit gate that is configured to conditionally flip a state of a target quantum bit based on a state of a control quantum bit;
wherein a number of unique layers of the plurality of layers of the same type of controlled two-qubit gate in the sequence of layers is no greater than a number of unique labels in the given set of labels for the connectivity graph.

2. The device of claim 1, wherein each layer of the same type of controlled two-qubit gate comprises a set of the controlled two-qubit gates which correspond to edges in the connectivity graph which are assigned the same label.

3. The device of claim 1, wherein each controlled two-qubit gate corresponds to a respective pair of quantum bits represented by a respective pair of vertexes in the connectivity graph, which is connected by an edge.

4. The device of claim 1, wherein in performing the process to generate the quantum circuit, the processing circuitry is configured to perform a backward iterative process that is configured to start with the target superposed state of the quantum bit register and determine a sequence of the plurality of layers of the same type of controlled two-qubit gate in a reverse order until reaching a state of the quantum bit register in which only one quantum bit of the quantum bit register has a state of 1 to which the single-qubit gate in the initial layer of the quantum circuit is applied.

5. The device of claim 1, wherein in performing the process to generate the quantum circuit, the processing circuitry is configured to perform a forward iterative process that is implemented using the connectivity graph having a tree structure with a root node that is initialized with a state of 1, wherein the forward iterative process propagates the state of the root node down to nodes of the tree structure to generate a sparse state.

6. The device of claim 5, wherein in performing the process to generate the quantum circuit, the processing circuitry is configured to:
generate a quantum circuit to prepare the sparse state; and
add one or more layers to the quantum circuit to produce the target superposed state of the quantum bit register from the sparse state.

7. The device of claim 1, wherein in performing the process to generate the quantum circuit, the processing circuitry is configured to:
generate a sparse state of the target superposed state on a linear nearest-neighbor connected graph;
generate a quantum circuit to prepare the sparse state; and
add one or more layers to the quantum circuit to produce the target superposed state of the quantum bit register from the sparse state.

8. The device of claim 7, wherein in generating the sparse state of the target superposed state on the linear nearest-neighbor connected graph, the processing circuitry is configured to derive the linear nearest-neighbor connected graph from a grid array of quantum bits.

9. A method, comprising:
generating a quantum circuit for preparing a target superposed state of a quantum bit register on a connectivity graph which comprises edges and vertexes in which each edge is assigned one label of a given set of unique labels such that no vertex of the connectivity graph is incident to two edges assigned with a same label, wherein generating the quantum circuit comprises:
generating an initial layer of the quantum circuit, wherein the initial layer comprises a single-qubit gate that is configured to place the quantum bit register in an initial superposed state; and
generating a sequence of layers of the quantum circuit following the initial layer, which are configured to generate the target superposed state of the quantum bit register, wherein the sequence of layers comprises a plurality of layers of a same type of controlled two-qubit gate that is configured to conditionally flip a state of a target quantum bit based on a state of a control quantum bit;
wherein a number of unique layers of the plurality of layers of the same type of controlled two-qubit gate in the sequence of layers is no greater than a number of unique labels in the given set of labels for the connectivity graph.

10. The method of claim 9, wherein each layer of the same type of controlled two-qubit gate comprises a set of the controlled two-qubit gates which correspond to edges in the connectivity graph which are assigned the same label.

11. The method of claim 9, wherein each controlled two-qubit gate corresponds to a respective pair of quantum bits represented by a respective pair of vertexes in the connectivity graph, which is connected by an edge.

12. The method of claim 9, wherein the quantum circuit is generated by a process which comprises performing a backward iterative process that is configured to start with the target superposed state of the quantum bit register and determine a sequence of the plurality of layers of the same type of controlled two-qubit gate in a reverse order until reaching a state of the quantum bit register in which only one quantum bit of the quantum bit register has a state of 1 to which the single-qubit gate in the initial layer of the quantum circuit is applied.

13. The method of claim 9, wherein the quantum circuit is generated by a process which comprises performing a forward iterative process that is implemented using the connectivity graph having a tree structure with a root node that is initialized with a state of 1, wherein the forward iterative process propagates the state of the root node down to nodes of the tree structure to generate a sparse state.

14. The method of claim 13, further comprising:
generating a quantum circuit to prepare the sparse state; and
adding one or more layers to the quantum circuit to produce the target superposed state of the quantum bit register from the sparse state.

15. The method of claim 9, wherein the quantum circuit is generated by a process which comprises:
generating a sparse state of the target superposed state on a linear nearest-neighbor connected graph;
generating a quantum circuit to prepare the sparse state; and
adding one or more layers to the quantum circuit to produce the target superposed state of the quantum bit register from the sparse state.

16. The method of claim 15, wherein generating the sparse state of the target superposed state on the linear nearest-neighbor connected graph, comprises deriving the linear nearest-neighbor connected graph from a grid array of quantum bits.

17. A computer program product for performing a process to generate a quantum circuit for preparing a target superposed state of a quantum bit register on a connectivity graph which comprises edges and vertexes in which each edge is assigned one label of a given set of unique labels such that no vertex of the connectivity graph is incident to two edges assigned with a same label, the computer program product comprising:
one or more computer readable storage media, and program instructions collectively stored on the one or more computer readable storage media, the program instructions comprising:
program instructions to generate an initial layer of the quantum circuit, wherein the initial layer comprises a single-qubit gate that is configured to place the quantum bit register in an initial superposed state; and
program instructions to generate a sequence of layers of the quantum circuit following the initial layer, which are configured to generate the target superposed state of the quantum bit register, wherein the sequence of layers comprises a plurality of layers of a same type of controlled two-qubit gate that is configured to conditionally flip a state of a target quantum bit based on a state of a control quantum bit;
wherein a number of unique layers of the plurality of layers of the same type of controlled two-qubit gate in the sequence of layers is no greater than a number of unique labels in the given set of labels for the connectivity graph.

18. The computer program product of claim 17, wherein each layer of the same type of controlled two-qubit gate comprises a set of the controlled two-qubit gates which correspond to edges in the connectivity graph which are assigned the same label.

19. The computer program product of claim 17, wherein each controlled two-qubit gate corresponds to a respective pair of quantum bits represented by a respective pair of vertexes in the connectivity graph, which is connected by an edge.

20. The computer program product of claim 17, wherein program instructions for generating the quantum circuit, comprise:
program instructions to generate a sparse state of the target superposed state on a linear nearest-neighbor connected graph;
program instructions to generate a quantum circuit to prepare the sparse state; and
program instructions to add one or more layers to the quantum circuit to produce the target superposed state of the quantum bit register from the sparse state.
